(19) United States
(12) Patent Application Publication
(10) Pub. No.: US 2024/0090506 A1
(43) Pub. Date: Mar. 21, 2024

(54) SURFACE MODIFICATION TO REGULATE PLANT GROWTH

(71) Applicant: BIND-X GMBH, Planegg (DE)

(72) Inventors: Jan-Philip MERKL, Hohenschäftlarn (DE); Luitpold FRIED, München (DE)

(21) Appl. No.: 18/254,025

(22) PCT Filed: Nov. 24, 2020
(86) PCT No.: PCT/EP2020/083150

§ 371 Date: May 23, 2023

(51) Int. Cl. A01N 59/00; A01N 25/00

(52) U.S. Cl. CPC A01N 59/00; A01N 25/00

(57) ABSTRACT

The present invention primarily relates to the use of a mixture to prevent or reduce plant growth, preferably weed growth, on/in a substrate by hardening said substrate. The invention further relates to a method for preventing or reducing plant growth, preferably weed growth, on/in a substrate and to a mixture for preventing or reducing plant growth, preferably weed growth.

The present invention primarily relates to the use of a mixture as defined herein to prevent or reduce plant growth, preferably weed growth, on/in a substrate by hardening said substrate. The invention further relates to a method for preventing or reducing plant growth, preferably weed growth, on/in a substrate comprising or consisting of the steps as defined herein and to a mixture as defined herein for preventing or reducing plant growth, preferably weed growth.

Further aspects of the present invention will arise from the description below, in particular from the examples, as well as from the attached patent claims.

The uncontrolled growth of weeds is a constant and growing problem in agriculture, in cities and municipalities and in the area of home gardens. In the agricultural sector, for example, it leads to yield losses. As the global food demand is growing, yield losses are unacceptable for the food supply chains. Uncontrolled growth of weeds is also perceived as a safety threat to municipal paths and as very disturbing and unattractive on paths and other surfaces.

For this reason, weeds are combated and/or destroyed by thermal methods such as flaming or by manual or automated weeding. The use of chemical agents (herbicides) to prevent or reduce weed growth or to kill existing plants is also widely used. However, most herbicides exhibit (acute) toxicity, are classified or suspected to be carcinogenic and/or cause environmental problems in the short and long term. Furthermore, it can currently be observed that more and more resistances against herbicides are being developed. Therefore, they must be used in higher quantities or new combinations, which further increases the negative aspects mentioned above as well as the cost of their use. In general, with any of the before mentioned methods, the treated areas are quickly repopulated by weeds through uncontrolled seed inflow and/or residual seeds in the soil.

Chemical agents that prevent or reduce plant growth usually interact with certain biosynthetic pathways within the plant. Thus, they are selective toxins for certain plants. Due to their designated chemical structure, these chemicals exhibit risks for other plants, humans and/or the entire eco system. They may contain toxic elements, e.g. tin or fluorine. Use of herbicides containing these elements also leads to accumulation in the environment and reduces or inhibits the biodegradation of such products. Most chemical herbicides need to be certified and applied by skilled workers. Depending on the water solubility and degradation properties, the products or metabolites of the herbicides are washed out and, thus, exposed to the environment.

Thermal processes as well as manual or automated weeding are labor and/or time intensive and need quick response times upon weed sprouting and/or growth. Also, the presence of humans and/or machines on the field may destroy the wanted plants and the effect is usually of short duration and needs, often multiple, repetitions.

Some solidification methods exist to suppress the growth of weeds. Most of these methods are based on cementitious systems, e.g. silicate cement, magnesia binders, aluminate cement or a mixture of slag and calcium oxide. JPH06245680A, for example, discloses the formation of a hardened layer on a surface with a weed controlling composition consisting of a mixture of cement and sodium silicate. These approaches have in common, that the cementitious binders are usually contaminated with heavy metals such as nickel and chromium(VI), which are strongly regulated in agricultural applications. Besides this, by a constant use of such binders, the heavy metals accumulate in the agricultural soil and plants, which is not accepted by farmers and customers.

Also, weed proof mats or nets are described to reduce weed growth (e.g. in JP2019024348A), however, their large-scale application is labor intensive. Incomplete removal, e.g. due to mechanical stress on the field and small parts being carried away by the wind, leads to the accumulation of plastic in the environment (so-called white pollution).

It was therefore the primary object of the present invention to provide a means for preventing or reducing plant growth, preferably weed growth, that would overcome the problems described above.

According to a first aspect of the present invention, the stated object is achieved by the use of a mixture comprising or consisting of the following components
(a) one or more alkali silicates selected from the group consisting of lithium silicate, sodium silicate, potassium silicate, rubidium silicate, caesium silicate and mixtures thereof,
(b) one or more performance modifiers, preferably as defined herein below,
(c) optionally: one or more hardeners, preferably as defined herein below,

to prevent or reduce plant growth, preferably weed growth, on/in a substrate by hardening said substrate.

In the course of the studies underlying the present invention, it was surprisingly found that a mixture as described herein very efficiently prevents or reduces plant growth, preferably weed growth, on/in a substrate by hardening said substrate when applied to said substrate.

The hardening of the substrate during the use according to the invention is caused by a reaction or interaction between the substrate and all components of the mixture (or between the substrate and one or more component(s) of the mixture) and/or by a reaction or interaction between the components of the mixture with one another. As a consequence, one or more layer(s) or area(s) of increased hardness is/are formed on and/or in and/or throughout (in the following “on/in”) the substrate. The increased hardness of the substrate achieved by the use according to the invention is such that it results in the formation of one or more plant, preferably weed, penetration resistant layer(s) or area(s) on/in the substrate, thus leading to a prevention or reduction of plant growth, preferably weed growth, on/in said substrate.

As indicated above, within the framework of the present text, the terms “hardening of a/the substrate” and “forming a hardened layer or area on/in a/the substrate” relate to the formation of one or more plant, preferably weed, penetration resistant layer(s) or area(s) on/in the substrate. Within the present text, a hardened layer or area on/in a substrate obtained by the use or method according to the invention may alternatively or additionally be more flexible and/or elastic and/or coherent than the corresponding untreated layer or area of said substrate (as long as the increased flexibility and/or elasticity and/or cohesion leads to the formation of a plant, preferably weed, penetration resistant layer or area on/in the substrate). A well performing mixture used according to the invention preferably leads to—after reaction—a balance between breaking force and elastic modulus of the formed hardened layer(s) or area(s).

Within the framework of the present text, the reference to a plant, preferably weed, penetration resistant layer or area on/in the substrate preferably indicates that it is not the initial sprouting of plants, preferably weeds, in/on the substrate that is prevented or reduced by the use according to the invention, but that the growth of plants, preferably weeds, is prevented or reduced by the formation of one or more hardened layer(s) or area(s) on/in the substrate (as described above) that is/are resistant to plant, preferably weed, penetration. Plants, preferably weeds, may germinate, but do not grow to the surface of the substrate as their growth is hindered by the formation of a plant, preferably weed, penetration resistant layer or area on/in the substrate at an early seeding stage. Moreover, the plants, preferably weeds, cannot absorb sufficient light and are unable to grow due to the formation of the plant, preferably weed, penetration resistant layer or area on/in the substrate. Plants, preferably weeds, would have to penetrate the surface of the substrate to reach illuminated regions for photosynthetic activity. As surface penetration of the growing plant, preferably weed, is fully hindered or reduced by the use according to the invention, plant growth, preferably weed growth, is prevented or reduced. Consequently, the application of any chemical agents such as herbicides, that would interfere with biochemical processes within the plants or seeds thereof, and would lead to the disadvantages described above, may advantageously be omitted.

In a three-dimensional, rectangular coordinate system, z would describe the direction from the sprout towards the light, whereas the x and y direction describe the lateral coordinates. Penetration of a body, preferably of a plant or weed, through a medium or substrate means that the respective body is able to move through the said medium or substrate. If no penetration is possible, the energy and/or force of the penetrating body is not sufficient to change the geological properties of said medium or substrate.

To exhibit efficient plant, preferably weed, penetration resistance, the hardened substrate generated by the use according to the invention does not necessarily have to exhibit high breaking forces. Instead, the hardened layer(s) or area(s) in/on the substrate may exhibit a stress-strain tensor and/or elastic tensor describing the deformation behavior under stress of such layer(s) or area(s), which hinders the penetration of plants, preferably weeds, to the surface of the substrate. In comparison to the stress-strain tensor and/or elastic tensor of the substrate (e.g. soil) before the use of the mixture, the tensors are changed due to the use according to the invention. Stress strain tensors and/or elastic tensors of substrates (e.g. soils) being resistant to plant, preferably weed, penetration typically exhibit the following properties: Linear elasticity until high stresses (e.g. higher than the translation energy of sprouting and/or growing weeds), high stiffness in z-direction resulting in higher critical load for failure (e.g. higher failure load than the energy of sprouting and/or growing weeds). This preferably leads to a balance between breaking force and elastic modulus of the formed layer, preferably resulting in effective plant, preferably weed, control.

The breaking force of the hardened layer(s) or area(s) on/in the substrate generated by the use according to the invention corresponds to the breaking force (in Newton (N)) that must be applied to break said layer(s) or area(s). The breaking of a hardened layer or area is the point at which permanent plastic deformation of the layer or area results in physical separation of the body into multiple parts and thus the layer or area can no longer be modelled as one material element. This is called failure of the hardened layer or area. The breaking force (maximum value of the force measurement) can be determined using the method based on the standardized test method for strength determination in cement DIN EN 196-1:2005-05. According to the manufacturer, the breaking force is measured using a digital (breaking) force instrument. A test piece is pressed into the specimen (until failure) with the aid of a crank test stand and the applied force is continuously measured. The average breaking force is calculated from several measurements (>3). The average breaking force of the hardened substrate (obtained by the use according to the invention) is preferably between 0.5 and 1000 N, more preferably between 1 and 300 N, most preferably between 1.5 and 100 N. The breaking force is applied in −z direction (inverse z-direction) and the plants and/or weeds and/or sprouts thereof grow in z direction. Thus, measurements in z direction are more preferred over measurement of the breaking force.

The stiffness and critical load in z direction can be measured using a pull out test: A metal body with a cylindrical body (h=2.12 mm, d=35 mm) exhibiting a bar of 6 mm diameter and 50 mm height in the middle (side view is T-shaped) is placed where the seeds/sprouts are usually placed. Sifted land soil, for example, is placed on top of this cylindrical body in the desired soil height. After the application of the mixture as defined herein and incubation for the desired time, preferably 7 days, the bar is connected to a device being able to measure stress and strain in z direction. The metal body is pulled out slowly from the soil sample and the stress/strain behavior is measured. The stress and/or strain of the hardened layer or area until non-linear elastic behavior is observed. Preferably, it is increased by at least 10%, preferably by at least 20%, more preferably by at least 50%, most preferably by at least 100%, compared to the untreated soil control, to yield efficient weed penetration resistance. Most preferably, the cylindrical body is pulled through a hole (d=45 mm), which is present inside a sample holder, during the test. The sample holder is placed and fixed on top of the hardened soil.

Most preferably, the work done to the body until failure is increased by at least 10%, preferably by at least 20%, more preferably by at least 50%, most preferably by at least 100%, compared to the untreated soil control.

Most preferably, the use according to the invention leads to hardening of/in a substrate changing the Atterberg limits (e.g. shrinkage limit, plastic limit, and liquid limit, being critical water levels) of said substrate by at least 5%, preferably by at least 10%, preferably by at least 20%, more preferably by at least 50%, most preferably by at least 100%, compared to the untreated substrate, resulting in efficient plant, preferably weed, control. The Atterberg limit can be determined with an associated test, preferably a norm test e.g. ASTM D4318-17e1 and/or ISO/TS 17892-12:2004 or any other test suitable for determining Atterberg limits. It is thus preferred if hardening of/in the substrate changes the consistency, engineering properties and/or behavior of said substrate resulting in efficient plant, preferably weed, control.

Preferably, the hardening of the substrate, i.e. the formation of the plant, preferably weed, penetration resistant layer(s) or area(s) on/in the substrate, by the use according to the invention exhibits a degree of efficiency of over 0%, preferably over 25%, more preferably over 50%, more preferably over 75%, most preferably over 90%, when compared to the untreated substrate.

In the context of the present text, the term plant stands for land plants (kingdom Plantae), including all gymnosperms, angiosperms, preferably monocotyledons and dicotyledons, mosses and ferns, i.e. the monophyletic group of embryophyta characterized by a common, functionally understood feature complex of several synapomorphies. Their main groups are the liverworts (Marchantiopsida), hornworts (Anthocerotopsida) and mosses (Bryopsida), which are often grouped in the paraphyletic moss group, lycopods (Lycopsida), horsetails (Equisetopsida) and ferns in the narrow sense (Filicopsida), grouped in the pteridophytes, as well as the monophyletic seed plants (Spermatophyta) with the angiosperms and the different development lines of the gymnosperms.

In the context of the present text, the term weed stands for all plants (including mosses and ferns) of the spontaneous or undesirable accompanying vegetation, in particular in agricultural or urban areas, grassland or (home) gardens, which develop from the seed potential of the soil (as first shoots or re-sprouts), via runners, preferably root and stem runners, plant fragments or seed inflows, and which are preferably not specifically cultivated there. Synonyms for weed are wild herb and wild plant. In the context of the present text, the term cultivated plant and/or wanted plant stands for plants whose growth or presence is desired.

Unless defined otherwise, technical and scientific terms used herein have the same meaning as commonly understood by one of ordinary skill in the art to which this invention belongs.

In case a compound falls under both the term “performance modifier” (cf. component (b) of the mixture as defined herein) and the term “hardener” (cf. component (c) of the mixture as defined herein), then the compound is to be allocated to both components. In such case the weight or concentration of said compound is to be allocated in a 50:50 proportion to the performance modifiers (component (b) of the mixture as defined herein) and the hardeners (component (c) of the mixture as defined herein).

According to a preferred embodiment, the mixture used according to the invention is a non-cementitious mixture, i.e. does not comprise any cement, preferably it does not comprise any silicate and/or aluminate cement.

According to another preferred embodiment, the mixture used according to the invention is not a joint filling mixture or joint filling sand (i.e. a mixture or sand that is used to fill the gaps between blocks or stones to create, for example, paths, driveways or roads). Joint filling mixtures or sands usually comprise a large portion of sand.

Alkali silicates are used in the state of the art in joint sands to inhibit weed growth inside the joints (WO 2005/025316A1, EP2570028). In these cases, the prevention or reduction of the weed growth is caused by the low availability of plant essential elements such as potassium and magnesium and/or the high alkalinity generated by the alkali silicate(s) in the joint filling sand, not by hardening of the substrate. According to the manufacturer information, joint sands shall be placed 40 mm deep into the joint to be filled and their use is limited to joints of only 1-5 mm in width. Thus, the application of said sands based on the used quantities and specification is not applicable for large scale application such as agricultural applications.

The skilled person is aware that the properties of a mixture are influenced by all components of the mixture. For example, one could not easily replace and/or remove the aggregates such as gravel, sand or silt from a concrete or mortar mixture while maintaining the same material properties. It was thus surprising that the use of a mixture as described herein allows mechanical plant, preferably weed, prevention or reduction by hardening a substrate (e.g. different agricultural soils).

A preferred embodiment of the invention relates to the use of a mixture comprising or consisting of the following components
(a) one or more alkali silicates selected from the group consisting of lithium silicate, sodium silicate, potassium silicate, rubidium silicate, caesium silicate and mixtures thereof,
(b) one or more performance modifiers,
(c) one or more hardeners,

to prevent or reduce plant growth, preferably weed growth, on/in a substrate by hardening said substrate.

Another preferred embodiment of the invention relates to the use of a mixture comprising or consisting of the following components
(a) one or more alkali silicates selected from the group consisting of lithium silicate, sodium silicate, potassium silicate, rubidium silicate, caesium silicate and mixtures thereof,
(b) one or more performance modifiers,
(c) optionally: one or more hardeners,

together with water (preferably tap water) to prevent or reduce plant growth, preferably weed growth, on/in a substrate by hardening said substrate.

Another preferred embodiment of the invention relates to the use of a mixture comprising or consisting of the following components
(a) one or more alkali silicates selected from the group consisting of lithium silicate, sodium silicate, potassium silicate, rubidium silicate, caesium silicate and mixtures thereof,
(b) one or more performance modifiers,
(c) one or more hardeners,

together with water (preferably tap water) to prevent or reduce plant growth, preferably weed growth, on/in a substrate by hardening said substrate.

Preferably, the mixture used according to the invention contains a total amount of 10 to 90 wt.-% (weight percent), preferably 15 to 85 wt.-%, preferably 20 to 80 wt.-%, more preferably 25 to 75 wt.-%, of component (a), based on the total weight of the mixture.

Preferably, the mixture used according to the invention contains a total amount of 10 to 90 wt.-%, preferably 15 to 85 wt.-%, preferably 20 to 80 wt.-%, more preferably 25 to 75 wt.-%, of component (b), based on the total weight of the mixture.

Preferably, if present, the mixture used according to the invention contains a total amount of 1 to 70 wt.-%, preferably 2 to 60 wt.-%, preferably 5 to 50 wt.-%, more preferably 10 to 40 wt.-%, of component (c), based on the total weight of the mixture.

Preferably, the one or more alkali silicate(s) of component (a) of the mixture used according to the invention have a low particle size (diameter), respectively, preferably exhibiting a maximum in the particle size distribution of below 500 μm, more preferably below 250 μm, most preferably below 125 μm.

The particle size can be determined by using light and/or x-ray scattering methods such as laser granulometry, small angle x-ray scattering and/or electron microscopy investigations. For solid alkali silicates, the use of light scattering and electron microscopy is preferred, whereas for liquid alkali silicates, the use of x-ray scattering and light scattering is preferred.

In the context of the present text, the silicon alkali mixture ratio (SAMR) is the number of moles of silicon n(Si) divided by the total numbers of moles of the alkali oxides (expressed as n(X₂O) with X=Li, Na, K, Rb, Cs) contained in the mixture used according to the invention as defined herein:

SAMR=n(Si)/[n(Li₂O)+n(Na₂O)+ₙ(K₂O)+n(Rb₂O)+n(Cs₂O)]

According to a preferred embodiment, the SAMR is between ≥0.5 and ≤150, preferably ≥0.75 and ≤100, more preferably ≥1.0 and ≤50, more preferably ≥1.25 and ≤25, more preferably ≥1.5 and ≤12.5, more preferably ≥1.75 and ≤6, most preferably ≥2.0 and ≤3.5, in the mixture used according to the invention.

According to a preferred embodiment, the mixture as defined herein is used at the location where plant growth, preferably weed growth, is to be reduced or prevented. Hence, removal of the substrate on/in which plant growth, preferably weed growth, is to be reduced or prevented from said location is preferably not necessary to prevent or reduce plant growth, preferably weed growth, and is therefore preferably not part of a use according to the invention.

According to another preferred embodiment, removal of the substrate on/in which plant growth, preferably weed growth, is to be reduced or prevented, from its original location is followed by mixing said substrate with the mixture as defined herein at a different location (e.g. in a mixer) and (re)application of the resulting substrate-mixture combination at the original location (or alternatively at a different location), where plant growth, preferably weed growth, is to be reduced or prevented.

Furthermore, in the context of the use according to the invention as described herein, advantageously no compacting of the substrate on/in which the plant growth is to be reduced or prevented, or of the substrate-mixture combination is necessary, in order to achieve a prevention or reduction of plant growth, preferably weed growth, and thus preferably is not part of a use according to the invention.

According to a preferred embodiment of the invention, a reaction takes place during use which changes the solubility of one or more component(s) of the mixture or of the resulting reaction product, and thus allows the formation of one or more water resistant layer(s) or area(s) on/in the substrate, which is/are not easily washed out.

A preferred embodiment of the invention relates to the use of a mixture as defined herein, wherein the one or more hardened layer(s) or area(s) formed on/in the substrate has/have a (water) coefficient of permeability of greater than 10⁻⁹ to 10⁰ m/s, preferably greater than 10⁻⁹ to 10⁻³ m/s, more preferably greater than 10⁻⁸ to 10⁻³ m/s.

In the context of the present text, the term “water permeable hardened layer or area” means a layer or area with a (water) coefficient of permeability greater than 10⁻⁶ to 10⁰ m/s, and the term “water semipermeable layer or area” means a layer or area with a (water) coefficient of permeability of greater than 10⁻⁹ to 10⁻⁶ m/s, and the term “water impermeable layer or area” means a layer or area having a (water) coefficient of permeability of 10⁻¹¹ (or less) to 10⁻⁹ m/s. Common methods for determining the coefficient of permeability comprise laboratory methods (e.g. ram core probing and subsequent determination of water saturated permeability in the laboratory) and field methods (e.g. determination of the infiltration rate with a double ring infiltrometer).

A preferred embodiment of the use according to the invention leads to a high durability of the hardened layer(s) or area(s) formed on/in the substrate and thus a long-term plant, preferably weed, growth prevention or reduction.

Preferably, the components of the mixture used according to the invention are directly applied to the surface of the substrate (pre-mixed or partly pre-mixed or one after the other), preferably in solid form.

The combination of alkali silicates (component (a)) and performance modifiers (component (b)) in the use according to the invention is particularly advantageous, since it leads to the formed plant, preferably weed, resistant layer(s) or area(s) being free of cracks.

According to a preferred embodiment, one or the, several or all performance modifier(s) of component (b) is/are selected from the group consisting of
(i) (bio)polymers selected from the group consisting of
   cellulose and derivatives thereof, starch and derivatives thereof, lignin and derivatives thereof, preferably lignin sulfonates, kraft-lignins and lignin carboxylates, pectins and derivatives thereof, xanthan and derivates thereof, guarethers and derivatives thereof;
   chitin and derivatives thereof, algin and derivatives thereof, chitosan and derivatives thereof, cylcodextrins and derivatives thereof, dextrins and derivatives thereof;
   natural glues, hydrogel builders, plant lime, latex, rubber and derivatives thereof;
   proteins and peptides comprising one or more of the amino acids selected from the group consisting of alanin, glycin, lysin, asparagin, glutamin, glutamate and non-proteinogenic amino acids;
   industrial substances, residual polymeric substances and industrial by-products selected from the group consisting of industrial effluents, preferably corn steep liquor, lactose mother liquor, protein lysates and molasses, vegetable meals, preferably corn gluten meal, pea meal, fruit meals and protein wastes, preferably from yeast production, meat production, fruit production, vegetable production, egg production, dairy industry and papermaking;
   starch ethers, starch esters, starch carboxylates, cellulose esters, cellulose ethers, cellulose carboxylates, yeasts and derivatives or extracts thereof;
   liquid or dried polymer dispersions or polymers comprising organic acids, preferably sulfonic acids, carboxylic acids, peroxy carboxylic acids and thio carboxylic acids and salts thereof, sulfoxides, cyanates, thiocyanates, esters, ethers, thio ethers, oxides, thio oxides, amines, imines, hydrazines, hyrazones, amids, sulfates, nitriles, aldehydes, thio aldehydes, ketons, thioketons, oximes, alkohols, thiols, radicals, halogens, silanes, siloxanes, phosphates, phosponates, alkyls, allyls, aryls and derivatives thereof, wherein preferably the polymer(s) is/are biodegradable;
(ii) (poly)saccharides, extracellular substances and derivatives thereof selected from the group consisting of (poly)saccarides comprising lactose, glucose, fructose, saccharose and/or galactose, and microbial exopolysaccharides, preferably comprising lactose, saccharose, glucose, glucosamine, mannose, glycerin, gluconate, fructose and/or inulin;
(iii) organic acids and derivatives thereof, preferably selected from the group consisting of monocarboxylic acids, preferably formic acid, acetic acid, propionic acid, butyric acid, benzoic acid and salicylic acid, dicarboxylic acids, preferably oxalic acid, malonic acid, succinic acid, glutaric acid, adipic acid and maleic acid, fatty acids, keto acids, preferably pyruvic acid and acetoacetic acid, fruit acids, preferably malic acid and tartaric acid, hydroxy acids, preferably lactic acid, alpha hydroxy acids and beta hydroxy acids, tricarboxylic acids, preferably citric acid, more preferably carboxylates and esters of the before mentioned;
(iv) amino acids and derivatives thereof, preferably selected from the group consisting of alanin, glycine, lysine, glutamine, glutamate, and non-proteinogenic amino acids, preferably esters and amides thereof;
(v) substances changing the reaction mechanism, preferably retarders, accelerators, bleeding modifiers, hydrophilizers, hydrophobizers, air entraining agents, viscosity modifiers, expanders, accelerators, retarders, thickeners, plasticizers, seeding materials and nanoparticle structured materials;
(vi) viable microorganisms, preferably bacteria capable of forming polymers, non-viable microorganisms and parts thereof;
(vii) chemical and natural herbicides; fungicides; molluscicides; insecticides; emulsifiers; thixotropic agents.

Preferably, the performance modifiers in the mixture used according to the invention (component (b)) influence the reaction mechanism that leads to the hardening of the substrate. The reaction mechanism may be organic, inorganic or physical in nature and, for example, result in shrinkage reduction (shrinkage reducers), expansion (expansion agents), acceleration (accelerators), retardation (retarders), viscosity modification (e.g. plasticizers, thickeners), water retention (e.g. bleeding modifiers, water retention agents), water uptake (e.g. hydrophobizers), air entrainment (e.g. air entertainers, ventilators). The respective effect may be analyzed by means established in cement research (cf. e.g. Bauchemie, Plank et al., Chemische Technik—Prozesse and Produkte, Band 7: Industrieprodukte, Winnacker/Küchler, 5. Auflage (2004) or associated DIN-Norms, e.g. DIN 1164-1). As the mixtures described herein are preferably solid systems (based on alkali silicate), ‘cement’ in the designated norm shall be replaced by an alkali silicate, preferably a solid alkali silicate (reference system), and a mixture of the same alkali silicate and the substance to be classified as one of the performance modifiers, wherein the mixture preferably contains 1 wt.-%, more preferably 5 wt.-%, most preferably 10 wt.-% of substance to be tested as a performance modifier based on the total weight of the mixture of binder and substance to be tested. The norm shall be adapted as before mentioned and carried out by a person skilled in the art. If the outcome of the parameter (e.g. shrinkage, expansion, hardening time, maximum in the heat evolution, viscosity, yield stress, spread, flow measure) that is relevant for the designed effect (e.g. shrinkage reduction, expansion, acceleration, retardation, plasticization, thickening) in the mixture of the binder and the substance to be classified differs more than 10% from the reference system, the substance to be classified is considered to change the reaction mechanism, i.e. to be a performance modifier. Preferred norms that may be used are for example: ASTM C157M-17 and ASTM C596-18 for shrinkage and expansion (a substance changing the length by over 10% with respect to the reference system is either a shrinkage reducer or an expander), DIN EN 480-2 for acceleration and retardation (a substance changing the setting time by over 10% with respect to the reference system is a retarder or accelerator), DIN EN 480-4 for water retention (a substance changing the amount of water added where no bleeding occurs of more than 10% with respect to the reference system is a bleeding modifier), DIN EN 480-5 for water uptake (a substance changing the amount of water taken up by over 10% with respect to the reference system is a hydrophilizer or hydrophobizer), DIN EN 480-11 for air content (a substance changing the air content by over 10% with respect to the reference system is an air entraining agent), DIN EN 480-15 for viscosity (a substance changing the viscosity by over 10% with respect to the reference system is a viscosity modifier), C230M-20 for spread and flow (a substance changing the spread and/or flow by over 10% with respect to the reference system is a plasticizer), ASTM D7334-08(2013) for hydrophobization (a substance changing the contact angle by over 10% with respect to the reference system is a hydrophobizer or hydrophilizer). By changing the reaction mechanism, the presence of the performance modifier in a mixture used according to the invention preferably leads to a more effective plant, preferably weed, control than the control without the performance modifier.

Most preferably, the viable microorganisms are bacteria capable of forming organic polymers.

According to another preferred embodiment of the use according to the invention, the viable and/or non-viable microorganisms do not have the capability of forming carbonates.

According to another preferred embodiment, the mixture used according to the invention does not comprise any organisms capable of forming carbonate and/or of inducing and/or catalysing carbonate formation.

According to another preferred embodiment, the mixture used according to the invention does not comprise any enzymes capable of forming carbonate and/or of inducing and/or catalysing carbonate formation.

According to a most preferred embodiment, the mixture used according to the invention neither comprises any organisms nor any enzymes capable of forming carbonate and/or of inducing and/or catalysing carbonate formation.

According to another preferred embodiment of the use according to the invention, one or the, several or all performance modifier(s) is/are selected from the group consisting of cellulose and derivatives thereof, starch and derivatives thereof, lignin and derivatives thereof, preferably lignin sulfonates, kraft-lignins and lignin carboxylates, pectins and derivatives thereof, xanthan and derivates thereof, guarethers and derivatives thereof; chitin and derivatives thereof, algin and derivatives thereof, chitosan and derivatives thereof, cylcodextrins and derivatives thereof, dextrins and derivatives thereof; natural glues, hydrogel builders, plant lime, latex, rubber and derivatives thereof; proteins and peptides comprising one or more of the amino acids selected from the group consisting of alanin, glycin, lysin, asparagin, glutamin, glutamate and non-proteinogenic amino acids; starch ethers, starch esters, starch carboxylates, cellulose esters, cellulose ethers, cellulose carboxylates, yeasts and derivatives or extracts thereof; liquid or dried polymer dispersions or polymers comprising organic acids, preferably sulfonic acids, carboxylic acids, peroxy carboxylic acids and thio carboxylic acids and salts thereof, sulfoxides, cyanates, thiocyanates, esters, ethers, thio ethers, oxides, thio oxides, amines, imines, hydrazines, hyrazones, amids, sulfates, nitriles, aldehydes, thio aldehydes, ketons, thioketons, oximes, alkohols, thiols, radicals, halogens, silanes, siloxanes, phosphates, phosponates, alkyls, allyls, aryls and derivatives thereof, wherein preferably the polymer(s) is/are biodegradable.

According to another preferred embodiment of the use according to the invention, one or the, several or all performance modifier(s) is/are selected from the group consisting of cellulose and derivatives thereof, starch and derivatives thereof, lignin and derivatives thereof, preferably lignin sulfonates, kraft-lignins and lignin carboxylates, pectins and derivatives thereof, xanthan and derivates thereof, guarethers and derivatives thereof; chitin and derivatives thereof, algin and derivatives thereof, chitosan and derivatives thereof, cylcodextrins and derivatives thereof, dextrins and derivatives thereof; natural glues, hydrogel builders, plant lime, latex, rubber and derivatives thereof; proteins and peptides comprising one or more of the amino acids selected from the group consisting of alanin, glycin, lysin, asparagin, glutamin, glutamate and non-proteinogenic amino acids; starch ethers, starch esters, starch carboxylates, cellulose esters, cellulose ethers, cellulose carboxylates, yeasts and derivatives or extracts thereof; liquid or dried polymer dispersions or polymers comprising organic acids, preferably sulfonic acids, carboxylic acids, peroxy carboxylic acids and thio carboxylic acids and salts thereof, sulfoxides, cyanates, thiocyanates, esters, ethers, thio ethers, oxides, thio oxides, amines, imines, hydrazines, hyrazones, amids, sulfates, nitriles, aldehydes, thio aldehydes, ketons, thioketons, oximes, alkohols, thiols, radicals, halogens, silanes, siloxanes, phosphates, phosponates, alkyls, allyls, aryls and derivatives thereof, wherein preferably the polymer(s) is/are biodegradable; substances changing the reaction mechanism, preferably retarders, accelerators, bleeding modifiers, hydrophilizers, hydrophobizers, air entraining agents, viscosity modifiers, expanders, accelerators, retarders, thickeners, plasticizers, seeding materials and nanoparticle structured materials.

According to another preferred embodiment, one or the, several or all hardener(s), if present, is/are selected from the group consisting of
(viii) inorganic salts selected from the group consisting of alkali salts, earth alkali salts, metal salts and transition metal salts, preferably calcium, magnesium, aluminum and iron salts, more preferably calcium carbonate, calcium hydrogen carbonate, calcium cyanamide, calcium chloride, calcium hydroxide, calcium sulfate, magnesium carbonate, magnesium hydrogen carbonate, magnesium cyanamide, magnesium chloride, magnesium sulfate, aluminum sulfate, iron chloride, iron sulfate, and phosphates and derivatives thereof;

and/or
(ix) inorganic acids, preferably sulfuric acid, hydrogen halides, nitric acid and phosphoric acid;

and/or
(x) inorganic binders selected from the group consisting of cement, preferably silicate cement, aluminate cement, magnesia cement and phosphate cement, calcium sulfate, preferably gypsum, calcium oxide and phosphate binders;

and/or
(xi) minerals selected from the group consisting of clays, inorganic minerals comprising calcium carbonate and derivatives thereof, calcium alumo silicates, microsilica, aluminiumoxide, kaolin, bentonite and expanded glass granules.

Preferably, the calcium carbonate and/or calcium hydrogen carbonate (cf. inorganic salts) is supplied by tap water, which may be a component of the mixture used according to the invention.

Preferably, one or the, several or all hardener(s) in the mixture used according to the invention, if present, is/are selected from the group consisting of
(viii) inorganic salts selected from the group consisting of alkali salts, earth alkali salts, metal salts and transition metal salts, preferably calcium, magnesium, aluminum and iron salts, more preferably calcium carbonate, calcium hydrogen carbonate, calcium cyanamide, calcium chloride, calcium hydroxide, calcium sulfate, magnesium carbonate, magnesium hydrogen carbonate, magnesium cyanamide, magnesium chloride, magnesium sulfate, aluminum sulfate, iron chloride, iron sulfate, and phosphates and derivatives thereof;

and/or
(ix) inorganic acids, preferably sulfuric acid, hydrogen halides, nitric acid and phosphoric acid;

and/or
(x) inorganic binders selected from the group consisting of cement, preferably silicate cement, aluminate cement, magnesia cement and phosphate cement, calcium sulfate, preferably gypsum, calcium oxide and phosphate binders.

Most preferably, one or the, several or all hardener(s) in the mixture used according to the invention, if present, is/are selected from the group consisting of
(viii) inorganic salts selected from the group consisting of alkali salts, earth alkali salts, metal salts and transition metal salts, preferably calcium, magnesium, aluminum and iron salts, more preferably calcium carbonate, calcium hydrogen carbonate, calcium cyanamide, calcium chloride, calcium hydroxide, calcium sulfate, magnesium carbonate, magnesium hydrogen carbonate, magnesium cyanamide, magnesium chloride, magnesium sulfate, aluminum sulfate, iron chloride, iron sulfate, and phosphates and derivatives thereof;

and/or
(ix) inorganic acids, preferably sulfuric acid, hydrogen halides, nitric acid and phosphoric acid.

Preferably, the substrate comprises one or more material(s) selected from the group consisting of sand, soil, humus, crushed stone, gravel, clay, silt, sawdust, paper, cardboard, chipboard, softwood, limestone and coal.

More preferably, the substrate comprises one or more material(s) selected from the group consisting of soil, humus, crushed stone, gravel, clay, silt, sawdust, paper, cardboard, chipboard, softwood, limestone and coal.

Preferably, the substrate is an area of land selected from the group consisting of a garden area, a joint area of paving blocks and stones, an arable land, an orchard, a vineyard area, a tree nursery area, a park, a part of a developed land or urban area, an unpaved road, a footpath, a railway line, an industrially used area and an area between and before said areas of land.

More preferably, the substrate is an area of land selected from the group consisting of a garden area, an arable land, an orchard, a vineyard area, a tree nursery area, a park, a part of a developed land or urban area, an unpaved road, a footpath, a railway line, an industrially used area and an area between and before said areas of land.

Preferably, the mixture used according to the invention is present in liquid form, as a gel, paste, powder, granulate or aggregate or intermediate forms thereof.

In the context of the present text, powder and/or powdery means that 95 wt.-% of the mixture used according to the invention passes sieves with a mesh size of 4 mm (based on the total weight of said mixture, according to DIN EN 12620 Aggregates for Concrete).

Preferably, the content of liquid components, preferably of water, in the mixture used according to the invention that is in powder form is 25 wt.-% or less, more preferably 15 wt.-% or less, more preferably 10 wt.-% or less, more preferably 5 wt.-% or less, most preferably 2.5 wt.-% or less, based on the total weight of said mixture.

In the context of the present text, granulate means that 95 wt.-% of the of the mixture used according to the invention passes sieves with a mesh size of 16 mm (based on the total weight of said mixture, according to DIN EN 12620 Aggregates for Concrete). Preferably, the content of liquid components, preferably of water, in the mixture used according to the invention that is in granulate form is 25 wt.-% or less, more preferably 15 wt.-% or less, more preferably 10 wt.-% or less, more preferably 5 wt.-% or less, most preferably 2.5 wt.-5% or less, based on the total weight of said mixture.

In the context of the present text, aggregate means that 95 wt.-% of the mixture used according to the invention does not pass sieves with a mesh size of 16 mm (based on the total weight of said mixture, according to DIN EN 12620 Aggregates for Concrete). Preferably, the content of liquid components, preferably of water, in the mixture used according to the invention that is in aggregate form is 25 wt.-% or less, more preferably 15 wt.-% or less, more preferably 10 wt.-% or less, more preferably 5 wt.-% or less, most preferably 2.5 wt.-% or less, based on the total weight of said mixture.

The content of liquid components, preferably of water, in the mixture used according to the invention can be determined by standard methods known to the skilled person. For example, a gravimetric determination of the content of the liquid components can be performed by weighing the sample taken, heating it to a temperature above the boiling point of the liquid components for a sufficient period of time for drying and then weighing it again. From the difference in weight before and after drying, the content in % by weight of liquid components, preferably of water, can be determined.

The mixture used according to the invention may be present or used in the form of one liquid, gel, paste, powder, granulate or aggregate or in the form of two, three, four or more liquid and/or gel-like and/or paste-like and/or powdery and/or granulate and/or aggregate pre-mixtures, which may be stored separately from each other before use and which are mixed together before or during the use according to the invention. Most preferred is the use of a mixture of solids (powder(s) and/or granulate(s) and/or aggregate(s) and/or intermediate forms thereof).

According to a preferred embodiment of the use according to the invention, the components of the mixture are pre-mixed before the application to the substrate.

According to another preferred embodiment of the use according to the invention, the components of the mixture are applied to the substrate one after the other.

According to another preferred embodiment of the use according to the invention, component (a) is applied to the substrate first, followed by the application of either component (b) or of a mixture of components (b) and (c).

According to another preferred embodiment of the use according to the invention, component (b) or a mixture of components (b) and (c) is/are applied to the substrate first, followed by the application of component (a).

Particularly in the form of a powder and/or granulate and/or aggregate, i.e. in solid form, the mixture used according to the invention advantageously has a particularly long storage stability, preferably of at least 12 to 36 months.

A powder form of the mixture used according to the invention can be obtained by standard industrial processes known to the skilled person, e.g. drying, heat drying, spray drying, freeze drying, (low-temperature) vacuum drying, fluid bed drying and/or with the aid of filtration with filtering aids.

According to a preferred embodiment, the mixture is used to prevent weed growth on/in a substrate (e.g. an agricultural soil), where one or more wanted plant(s) is/are already present without harming the growth and/or viability of the wanted plant(s). Thus, preferably the mixture used according to the invention does not exhibit any toxicity towards the wanted plant.

According to another preferred embodiment, the mixture is used in combination with one or more chemical herbicide(s), thereby reducing the wash out effects on the herbicide(s) due to the hardening of the substrate. This advantageously reduces the required amount of herbicide(s).

Preferably, component (a) of the mixture used according to the invention comprises or consists of potassium silicate.

Most preferably, component (a) of the mixture used according to the invention consists of potassium silicate, i.e. potassium silicate is the only alkali silicate used.

In a preferred embodiment of the use according to the invention, the amount of mixture applied to the substrate or introduced into the substrate per application is less than 400 g/m², preferably less than 300 g/m², more preferably less than 200 g/m², most preferably less than 100 g/m² (the square meterage relating to the surface area of the substrate measured before the use according to the invention is carried out).

Preferably, in a use according to the invention, the mixture as defined herein is applied only once to the substrate.

More preferably, in a use according to the invention, the mixture as defined herein is applied two, three, four or more times to the same (area of) the substrate.

Preferably, the lateral dimensions of the substrate are greater than 0.5 cm, preferably greater than 1 cm, more preferably greater than 2 cm, most preferably greater than 5 cm, respectively.

Within the context of the present text, the term lateral dimensions refers to the length and the width of the substrate, respectively. Thus, both the length and the width of the substrate have to fulfill the size criteria defined above.

Preferably, the substrate hardened by the use according to the invention is a garden, a garden bed, a walking path or an area next to a road or a field.

Preferably, the lateral dimensions of the substrate are greater than 10 cm, preferably greater than 50 cm, more preferably greater than 1 m, more preferably greater than 5 m, most preferably greater than 10 m, respectively.

Preferably, the hardening of the substrate by the use according to the invention leads to the formation of a hardened layer on/in the substrate with a layer thickness of greater than 0 to 100 mm, preferably of 1 to 50 mm, preferably of 2 to 25 mm, most preferably of 3 to 10 mm.

The thickness of a hardened layer or area on/in the substrate can be determined by manual measurement after mechanical breakage of the layer using a caliper gauge. Alternatively, different (non-destructive) measuring methods from construction, agriculture, geology or other fields of application can be used (e.g. hand-held device MIT-SCAN-T2) depending on the thickness of the layer or area. The layer or area thickness of the hardened layer or area comprises the area of the substrate that is hardened, preferably solidified, by the use according to the invention.

According to a preferred embodiment, the use according to the invention additionally promotes the growth of wanted plants by means of erosion control, water evaporation control and/or the supply of nutrients.

As described above, the mixture as defined herein may be used according to the invention to prevent weed growth on/in a substrate (e.g. an agricultural soil), where one or more wanted plant(s) is/are already present (before the use according to the invention) without harming the growth and/or viability of the wanted plant(s). Hardening the substrate by the use according to the invention is advantageous for the wanted plant(s) that is/are already growing on/in the substrate since it provides erosion control, water evaporation control and/or a supply of nutrients to the wanted plant(s). Hardening the substrate by the use according to the invention leads to the prevention or reduction of weed growth, which is advantageous for the wanted plant(s) since they do not have to compete for space, water, light or nutrients with any weeds.

In another embodiment of the use according to the invention, the substrate is only hardened to such a degree that weed growth is prevented or reduced, but that the growth of wanted plants (which may be larger or stronger plants than weeds such as for example trees or shrubs) is still possible. Again, such embodiment is advantageous for the wanted plant(s), since it will provide erosion control, water evaporation control and/or a supply of nutrients to the growing or grown wanted plant(s). Moreover, the growth of weeds is prevented or reduced, which is advantageous for the growing or grown wanted plant(s) since they do not have to compete for space, water, light or nutrients with any weeds.

Another aspect of the present invention relates to a method for preventing or reducing plant growth, preferably weed growth, on/in a substrate comprising or consisting of the following steps:
(a) Identifying a substrate to be treated on/in which plant growth, preferably weed growth, is to be prevented or reduced,
(b) providing a mixture as defined herein or the separate components thereof,
(c) applying and/or introducing the mixture or components provided in step (b) onto/into the substrate to be treated in an amount sufficient to enable hardening of the substrate, and
(d) forming one or more hardened layer(s) or area(s) on/in the substrate so that plant, preferably weed, growth on/in the substrate is prevented or reduced.

According to a preferred embodiment of the method according to the invention, (only) an application of the mixture or components provided in step (b) onto the substrate to be treated takes place in step (c).

According to another preferred embodiment of the method according to the invention, an application and subsequent introduction, for example by intermixing, of the mixture or components provided in step (b) onto/into the substrate to be treated takes place in step (c).

According to a preferred embodiment of the method according to the invention, a step of removing the substrate identified in step (a) on/in which plant growth, preferably weed growth, is to be prevented or reduced, from its original location is not necessary to prevent or reduce plant growth and thus preferably is not part of a method according to the invention.

Furthermore, within the framework of the method according to the invention as described herein, advantageously no step of compacting the substrate on/in which the plant, preferably weed, growth is to be reduced or prevented is necessary to achieve a prevention or reduction of plant growth, preferably weed growth, and thus is preferably not part of a method according to the invention.

According to another preferred embodiment of the method according to the invention, the substrate or parts thereof identified in step (a) is/are removed from the original location, mixed with the mixture or components provided in step (b) in an amount sufficient to enable hardening of the substrate (for example in a mixer, corresponding to step (c)), the obtained substrate-mixture combination is returned to the original location of the substrate (or alternatively moved to another location), followed by step (d) as described herein.

Advantageously, it is normally sufficient to carry out steps (b) to (d) of the method according to the invention only once to achieve satisfactory plant, preferably weed, growth prevention or reduction.

However, according to a further preferred embodiment, steps (b) to (d) or (b) and (c) can be repeated once, twice, three times or more as required to achieve a particularly effective hardening of the substrate and thus a particularly effective plant, preferably weed, growth prevention or reduction.

Optionally, according to a further embodiment of the method according to the invention, one or more further steps may be carried out between steps (a) and (b) or between steps (b) and (c), such as, for example, the flaming of plants, preferably weeds, located on/in the substrate, manual removal (weeding) of plants, preferably weeds, located on/in the substrate, and/or the treatment of the plants, preferably weeds, located on/in the substrate, with chemical weed control agents. Said steps can also be repeated once, twice, three times or more, respectively.

Depending on the form (solid or liquid or gel-like or paste-like) of the mixture or components provided in step (b) of the method according to the invention (cf. above), the application and/or introduction in step (c) can take place in different ways. Powdery mixtures or components can, for example, be scattered onto the substrate to be treated and/or incorporated into the substrate. Liquid mixtures or components, for example, are preferably poured or sprayed onto the substrate to be treated and are optionally subsequently incorporated into the substrate, e.g. by mixing. Preferably, a single application and/or introduction of the mixture or components provided in step (b) onto/into the substrate to be treated is sufficient to form one or more hardened layer(s) or area(s) so that plant growth or weed growth on/in the substrate is prevented or reduced in step (d) of the method according to the invention.

According to a preferred embodiment of the method according to the invention, particularly in case in step (b) of the method according to the invention a mixture or the components thereof are provided in solid form and applied and/or introduced onto/into the substrate in step (c) of the method according to the invention in such solid form, an additional step (c′) takes place between steps (c) and (d). Such step (c′) encompasses the addition of water and/or an aqueous solution, preferably of tap water, to the substrate.

Thus, a preferred embodiment of the method according to the invention comprises or consists of the following steps:
(a) Identifying a substrate to be treated on/in which plant growth, preferably weed growth, is to be prevented or reduced,
(b) providing a mixture as defined herein or the separate components thereof,
(c) applying and/or introducing the mixture or components provided in step (b) onto/into the substrate to be treated in an amount sufficient to enable hardening of the substrate,
(c′) applying water and/or an aqueous solution to the combination of mixture and substrate, and
(d) forming one or more hardened layer(s) or area(s) so that plant, preferably weed, growth on/in the substrate is prevented or reduced.

A preferred application volume of the mixture as defined herein (if applicable, including any water contained therein or added thereto) that is applied and/or introduced onto/into the substrate in step (c) of the method according to the invention is at least 0.01 L/m², more preferably 0.1 L/m², more preferably at least 0.5 L/m², more preferably at least 1.0 L/m², more preferably at least 2.0 L/m², more preferably at least 3.0 L/m², at least 4.0 L/m² or at least 5.0 L/m², and/or preferably at most 20 L/m², more preferably at most 10 L/m².

Preferably, in step (b) of the method according to the invention, a mixture or the components thereof are provided in solid form and applied and/or introduced onto/into the substrate in step (c) of the method according to the invention before a predicted rainfall. Preferably, the water provided by the falling rain is sufficient for forming one or more hardened layer(s) or area(s) in step (d) of the method so that plant growth or weed growth on/in the substrate is prevented or reduced. Due to the optimized application form of the mixture or components thereof as defined herein, the hardened layer(s) or area(s) formed in step (d) of the method according to the invention advantageously is/are not washed away during this process. Thus, carrying out step (c) of the method according to the invention before or during heavy rain is preferred, as no significant wash out effects are observed. Also preferred is the use of pre-used water, industrial water, tap water exhibiting a hardness ≥1° dH, more preferably ≥10° dH, most preferably ≥20° dH in step (c′) of the method according to the invention, if present. Preferably, the addition of water to the substrate in step (c′) if present is carried out by drip irrigation.

For an effective formation of one or more hardened layer(s) or area(s) in step (d) of the method according to the invention, it is advantageous if the combination of mixture and substrate generated in step (c) of the method according to the invention has a water content of more than 25 wt.-% based on the total weight of said combination. If the mixture or components thereof is/are provided in a solid form (cf. above) in step (b) of the method according to the invention, and if the substrate is also essentially free from water, so that a water content of the combination of mixture and substrate generated in step (c) of 10 wt.-% or less, based on the total weight of the combination, would result, it is advantageous if the method according to the invention comprises a further step (b′) in which sufficient water and/or aqueous solution is/are added to the mixture or components thereof provided in step (b) before or during application and/or introduction onto/into the substrate to be treated, so that a water content of the combination of mixture and substrate generated in step (c) of more than 10 wt.-%, based on the total weight of said system, results. Alternatively or simultaneously, a corresponding amount of water and/or aqueous solution may be added to the substrate to be treated before or after application and/or introduction of the mixture and or components thereof provided in step (b) of the method according to the invention.

Thus, a preferred embodiment of the method according to the invention comprises or consists of the following steps:
(a) Identifying a substrate to be treated on/in which plant growth, preferably weed growth, is to be prevented or reduced,
(b) providing a mixture as defined herein or the separate components thereof,
(b′) addition of water and/or aqueous solution to the mixture or one or more component(s) thereof provided in step (b),
(c) applying and/or introducing the mixture or components obtained in step (b′) onto/into the substrate to be treated in an amount sufficient to enable hardening of the substrate, and
(d) forming one or more hardened layer(s) or area(s) so that plant, preferably weed, growth on/in the substrate is prevented or reduced.

Another preferred embodiment of the method according to the invention comprises or consists of the following steps:
(a) Identifying a substrate to be treated on/in which plant growth, preferably weed growth, is to be prevented or reduced,
(b) providing a mixture as defined herein or the separate components thereof,
(b′) addition of water and/or aqueous solution to the mixture or one or more component(s) thereof provided in step (b),
(c) applying and/or introducing the mixture or components obtained in step (b′) onto/into the substrate to be treated in an amount sufficient to enable hardening of the substrate,
(c′) applying water and/or an aqueous solution to the combination of mixture and substrate, and
(d) forming one or more hardened layer(s) or area(s) so that plant, preferably weed, growth on/in the substrate is prevented or reduced.

Furthermore, if the method according to the invention is used outdoors and the mixture or components thereof is/are applied and/or introduced onto/into the substrate in powdery form in step (c), it is advantageous not to carry out the method in case of heavy wind, for example. Heavy wind may potentially lead to a loss (drift) of the mixture or components thereof before the application of water and/or aqueous solution to the combination of mixture and substrate in step (c′), if present, or the formation of the hardened layer or area in step (d), which may prevent the formation of the hardened layer(s) or area(s) in step (d) or negatively affect its strength and/or thickness. This issue is less pronounced when the mixture or components thereof is/are applied and/or introduced onto/into the substrate in granulate or aggregate form in step (c).

After the step (c) or (c′), if present, of the method according to the invention, the formation of one or more hardened layer(s) or area(s) takes place in step (d) preferably over an incubation period of at least 1 hour, preferably of at least 4 hours, more preferably of at least 12 hours, most preferably of at least 24 hours, in which preferably no wind or artificial irrigation occurs, which may lead to a significant loss (drift) of the mixture as defined herein. The required incubation period for the formation of one or more hardened layer(s) or area(s) in step (d) of the method according to the invention depends on some environmental parameters, such as room or outside temperature and humidity, on the application volume and rate of the mixture or components thereof, and on the particle size of the mixture or components thereof. If during said incubation period of at least 1 hour, preferably of at least 4 hours, more preferably of at least 12 hours, wind or other environmental parameters should cause a significant loss of mixture as defined herein from the substrate, it is advantageous to repeat steps (b) to (d) of the method according to the invention as often as necessary, preferably once, twice, three times or more, until a sufficient thickness and strength of the hardened layer(s) or area(s) for preventing or reducing plant, preferably weed, growth on/in the substrate is achieved. In addition, or alternatively, it may be advantageous to repeat steps (b) to (d) of the method according to the invention, preferably once, twice, three times or more, if the thickness and/or strength of the hardened layer(s) or area(s) formed on/in the substrate decreases over time due to weathering and/or natural degradation and is thereby no longer sufficient to prevent or reduce plant, preferably weed, growth on/in the substrate.

A method as defined herein is preferred, wherein the hardened layer(s) or area(s) formed in step (d) of the method according to the invention has/have a (water) coefficient of permeability of greater than 10⁻⁹ to 10⁰ m/s, preferably greater than 10⁻⁹ to 10⁻³ m/s, further preferably greater than 10⁻⁸ to 10⁻³ m/s.

Optionally, after step (d) of the method according to the invention, a further step (e) may take place which comprises or consists of controlling whether plant, preferably weed, growth has been prevented or reduced. Said control may be carried out, for example, by determining the coverage rate of the plant or weed growth by manual visual assessment as described in the examples below. Step (e) of the method according to the invention, if present, may be repeated at regular intervals, if needed, e.g. every 24 or 48 hours, depending on the environmental parameters and dosage of the applications.

A method as described above is preferred, wherein the plant or weed is selected from the group consisting of dicotyls of the genera: Abutilon, Aegopodium, Aethusa, Amaranthus, Ambrosia, Anachusa, Anagaffis, Anoda, Anthemis, Aphanes, Arabidopsis, Atriplex, Barbarea, Beffis, Bidens, Bunias, Capsella, Carduus, Cassia, Centaurea, Chenopodium, Chrysanthemum, Cirsium, Conium, Conyza, Consolida, Convolvulus, Datura, Descurainia, Desmodium, Emex, Equisetum, Erigeron, Erodium, Erysimum, Euphorbia, Fumaria, Galeopsis, Galinsoga, Galium, Geranium, Heracleum, Hibiscus, Ipomoea, Kochia, Lamium, Lapsana, Lathyrus, Lepidium, Lithoserpermum, Linaria, Lindernia, Lycopsis, Malva, Matricaria, Mentha, Mercurialis, Mullugo, Myosotis, Papaver, Pharbitis, Plantago, Polygonum, Portulaca, Ranunculus, Raphanus, Rorippa, Rotala, Rumex, Salsola, Senecio, Sesbania, Sida, Sinapis, Sisymbrium, Solanum, Sonchus, Sphenoclea, Stachys, Stellaria, Taraxacum, Thlaspi, Trifolium, Tussaligo, Urtica, Veronica, Viola, Xanthium; dicotyls of the genera: Arachis, Beta, Brassica, Cucumis, Cucurbita, Helianthus, Daucus, Glycine, Gossypium, Ipomoea, Lactuca, Linum, Lycopersicon, Nicotiana, Phaseolus, Pisum, Solanum, Vicia; monocotyls of the genera: Aegilops, Agropyron, Agrostis, Alopecurus, Apera, Avena, Brachiaria, Bromus, Cenchrus, Commelina, Cynodon, Cyperus, Dactyloctenium, Digitaria, Echinochloa, Eleocharis, Eleusine, Eragrostis, Eriochloa, Festuca, Fimbristylis, Heteranthera, Imperata, Ischaemum, Juncus, Leptochloa, Lolium, Monochoria, Panicum, Paspalum, Phalaris, Phleum, Poa, Rottboellia, Sagittaria, Scirpus, Setaria, Sorghum; and monocotyls of the genera: Allium, Ananas, Asparagus, Avena, Hordeum, Oryza, Panicum, Saccharum, Secale, Sorghum, Triticale, Triticum, Zea; mosses of the lineages liverworts (Marchentiosida), hornworts (Anthocerotopsida), mosses (bryopsida).

According to a preferred embodiment of the method according to the invention, the, one, several or all of the plants are one or more liverwort(s) selected from the group consisting of the genera: Acolea, Acrobolbus, Acrochila, Acromastigum, Acroscyphella, Acroscyphus, Acrostolia, Adelocolia, Aitchisoniella, Alicularia, Affisonia, Allisoniella, Alobiella, Alobiellopsis, Amazoopsis, Amphicephalozia, Amphilophocolea, Andrewsianthus, Aneura, Anomacaulis, Anomoclada, Anomylia, Anthelia, Anthelis, Aphanolejeunea, Aplozia, Apomarsupella, Apometzgeria, Apotreubia, Arachniopsis, Arctoscyphus, Arnellia, Ascidiota, Asterella, Athalamia, Austrofossombronia, Austrolembidium, Austrolophozia, Austrometzgeria, Austroscyphus, Balantiopsis, Bazzania, Blasia, Blepharidophyllum, Blepharostoma, Brevianthus, Calycularia, Calypogeia, Calyptrocolea, Campanocolea, Castanoclobos, Cavicularia, Cephalojonesia, Cephalolobus, Cephalomitrion, Cephalozia, Cephaloziella, Cephaloziopsis, Ceratolejeunea, Cesius, Chaetophyllopsis, Chiastocaulon, Chiloscyphus, Chloranthelia, Chonecolea, Cladomastigum, Cladopodiella, Clandarium, Clasmatocolea, Cololejeunea, Colura, Conocephalum, Conoscyphus, Corsinia, Cronisia, Crossogyna, Cryptochila, Cryptocolea, Cryptocoleopsis, Cryptomitrium, Cryptostipula, Cryptothallus, Cuspidatula, Cyanolophocolea, Cyathodium, Cylindrocolea, Delavayella, Dendrobazzania, Dendromastigophora, Denotarisia, Dichiton, Dinckleria, Diplocolea, Diplophyllum, Douinia, Drepanolejeunea, Drucella, Dumortiera, Dumortieropsis, Enigmella, Eocalypogeia, Eoisotachis, Eopleurozia, Eotrichocolea, Eremonotus, Eucalyx, Evansia, Evansianthus, Exormotheca, Fossombronia, Frullania, Fuscocephaloziopsis, Gackstroemia, Geocalyx, Geothallus, Gerhildiella, Goebeliella, Goebelobryum, Gongylanthus, Gottschea, Gottschelia, Greeneothallus, Grollea, Gymnanthe, Gymnocoleopsis, Gymnomitrion, Gymnoscyphus, Gyrothyra, Haesselia, Haplomitrium, Harpalejeunea, Harpanthus, Hattoria, Hattorianthus, Hattoriella, Hepatostolonophora, Herbertus, Herpetium, Herpocladium, Herzogianthus, Herzogobryum, Heterogemma, Heteroscyphus, Horikawaella, Hyalolepidozia, Hygrobiellalwatsukia, Hygrolembidium, Hygrophila, Hymenophyton, Hypoisotachis, lsolembidium, Isotachis, Jamesonieffia, Jensenia, Jubula, Jubulopsis, Jungermannia, Jungermannites, Krunodiplophyfium, Kurzia, Kymatocalyx, Lamellocolea, Leiocolea, Leiomitra, Leiomyffia, Leioscyphus, Lejeunea, Lembidium, Lepidogyna, Lepidolaena, Lepidozia, Leptolejeunea, Leptophyllopsis, Leptoscyphopsis, Leptoscyphus, Lethocolea, Liochlaena, Lobatiriccardia, Lophocolea, Lophonardia, Lophozia, Lophoziopsis, Lunularia, Macrodiplophyfium, Maculia, Makinoa, Mannia, Marchantia, Marchesinia, Marsupefia, Marsupidium, Massula, Massularia, Mastigobryum, Mastigopelma, Mastigophora, Mastigopsis, Mesoptychia, Metacalypogeia, Metahygrobieffia, Metzgeria, Metzgeriopsis, Micrisophyffia, Microlejeunea, Microlepidozia, Micro pterygium, Mizutania, Mnioloma, Moerckia, Monocarpus, Monoclea, Monodactylopsis, Monosolenium, Myfilopsis, Nanomarsupeffia, Nardia, Neesioscyphus, Neogrollea, Neohodgsonia, Neotrichocolea, Noteroclada, Nothogymnomitrion, Nothostrepta, Notoscyphus, Noweffia, Obtusifolium, Odontolejeunea, Odontoschisma, Oleolophozia, Oxymitra, Pachyglossa, Pachyschistochila, Pallavicinia, Paracromastigum, Paraschistochila, Patarola, Pedinophyllopsis, Pedinophyfium, Peffia, Peltolepsis, Perdusenia, Perssonieffia, Petalophyfium, Phycolepidozia, Phyllothaffia, Physiotium, Physotheca, Pisanoa, Plagiochasma, Plagiochila, Plagiochilidium, Plagiochilion, Platycaulis, Plectocolea, Pleuranthe, Pleuroclada, Pleurocladopsis, Pleurocladula, Pleurozia, Podanthe, Podomitrium, Poreffia, Prasanthus, Preissia, Prionolobus, Protolophozia, Protomarsupeffia, Protosyzgieffia, Protosyzygieffia, Pseudocephalozia, Pseudocephalozieffia, Pseudolophocolea, Pseudolophozia, Pseudomarsupidium, Pseudoneura, Pseudotritomaria, Psiloclada, Pteropsiella, Ptilidium, Radula, Reboulia, Rhizocaulia, Rhodoplagiochila, Riccardia, Riccia, Ricciefia, Ricciocarpos, Rieffia, Roivainenia, Ruizanthus, Ruttnerella, Saccobasis, Saccogyna, Sandeothallus, Sarcocyphos, Sarcomitrium, Sauteria, Scapania, Scaphophyfium, Schiffneria, Schisma, Schistochila, Schistochilaster, Schistochilopsis, Schofieldia, Sendtnera, Seppeltia, Sewardiella, Simodon, Solenostoma, Southbya, Sphaerocarpos, Sphagnoecetis, Spruceffia, Steereeffia, Steereocolea, Stenorrhipis, Stephandium, Stephanieffia, Stephanieffidium, Stephensonieffia, Symphyogyna, Symphyogynopsis, Symphyomitra, Synhymenium, Syzygieffia, Taeniolejeunea, Targionia, Tegulifolium, Telaranea, Thallocarpus, Treubia, Triandrophyfium, Trichocolea, Trichocoleopsis, Trichostylium, Trichotemnoma, Trilophozia, Tritomaria, Tylimanthus, Vanaea, Vandiemenia, Verdoomia, Vetaforma, Wettsteinia, Wiesnereffia, Xenochfia, Xenothallus, Zoopsideffia, Zoopsis.

According to a further preferred embodiment of the method according to the invention, the, one, several or all of the plants are one or more moss(es) selected from the group consisting of the genera: Abiefinefia, Acanthocladieffia, Acanthocladium, Acanthodium, Acanthorrhynchium, Acaulon, Acaulonopsis, Achrophyllum, Acidodontium, Acrocladium, Acroporium, Acroschisma, Actinodontium, Actinothuidium, Adelothecium, Aequatoriella, Aerobryidium, Aerobryopsis, Aerobryum, Aerolindigia, Algaria, Aligrimmia, Alleniella, Allioniellopsis, Aloina, Aloinella, Alophosia, Alsia, Amblyodon, Amblyodum, Amblystegiella, Amblystegium, Amblytropis, Ambuchanania, Amphidium, Amphoridium, Amphoritheca, Anacalypta, Anacamptodon, Anacolia, Ancistrodes, Andoa, Andreaea, Andreaeobryum, Anictangium, Anisothecium, Anodon, Anodontium, Anoectangium, Anomobryum, Anomodon, Antitrichia, Aongstroemia, Aongstroemiopsis, Apalodium, Aphanorrhegma, Apiocarpa, Aplodon, Apterygium, Aptychella, Aptychopsis, Aptychus, Arbuscula, Arbusculohypopterygium, Archephemeropsis, Archidium, Arctoa, Argyrobryum, Arthrocormus, Aschisma, Aschistodon, Asteriscium, Astomiopsis, Astomum, Astrodontium, Astrophyllum, Atractylocarpus, Atrichopsis, Atrichum, Aulacomitrium, Aulacomnium, Aulacopilum, Austinella, Austrohondaella, Austrophilibertiella, Baldwiniella, Barbella, Barbellopsis, Barbula, Bartramia, Bartramiopsis, Beeveria, Beffibarbula, Benitotania, Bestia, Bissetia, Blindia, Boulaya, Brachelyma, Brachydontium, Brachymenium, Brachymitrion, Brachyodus, Brachysteleum, Bra chytheciastrum, Brachytheciella, Brachythecium, Brachytrichum, Braithwaitea, Braunfelsia, Braunia, Breidleria, Breutelia, Brothera, Brotherella, Brotherobryum, Bruchia, Bothnia, Brymela, Bryoandersonia, Bryobeckettia, Bryobrittonia, Bryobrothera, Bryoceuthospora, Bryochenea, Bryocrumia, Bryodixonia, Bryodusenia, Bryoerythrophyllum, Botohaplocladium, Bryohumbertia, Botomaltaea, Bryomanginia, Bryomnium, Bryonoguchia, Bryonorrisia, Bryophixia, Bryosedgwickia, Bryostreimannia, Bryotestua, Bryum, Buckiella, Bucklandiella, Burnettia, Buxbaumia, Caffialaria, Cafficladium, Cafficosta, Cafficostella, Cafficostellopsis, Caffiergidium, Caffiergon, Calohypnum, Calymperastrum, Calymperes, Calymperidium, Calymperopsis, Calyptopogon, Calyptothecium, Calyptrochaeta, Camptochaete, Camptodontium, Camptothecium, Campyliadelphus, Campylidium, Campylium, Campylodontium, Campylophyllum, Campylopodiella, Campylopodium, Campylopus, Campylostelium, Canalohypopterygium, Cardotia, Cardotiella, Caribaeohypnum, Catagoniopsis, Catagonium, Catharinea, CatharineIla, Catharomnion, Catoscopium, Cecalyphum, Ceratodon, Ceuthospora, Ceuthotheca, Chaetomitrella, Chaetomitriopsis, Chaetomitrium, Chaetophora, Chamaebryum, Chamberlainia, Chameleion, Cheilothela, Chenia, Chileobryon, Chionoloma, Chionostomum, Chorisodontium, Chryso-hypnum, Chrysoblastella, Chrysocladium, Chrysohypnum, Cinclidium, Circulifolium, Cirriphyllum, Cladastomum, Cladomnion, Cladophascum, Cladopodanthus, Cladopodanthus, Claopodium, Clasmatodon, Clastobryella, Clastobryophilum, Clastobryopsis, Clastobryum, Clavitheca, Cleistocarpidium, Cleistostoma, Climacium, Cnestrum, Codonoblepharon, Codonoblepharum, Codriophorus, Coelidium, Coleochaetium, Colobodontium, Conardia, Conomitrium, Conostomum, Coscinodon, Coscinodontella, Costesia, Craspedophyllum, Cratoneurella, Cratoneuron, Cratoneuropsis, Crosbya, Crossidium, Crossomitrium, Crumia, Crumuscus, Cryhphaea, Cryphaeadelphus, Cryptocarpon, Cryptodicranum, Cryptogonium, Cryptoleptodon, Cryptopapillaria, Cryptopodia, Cryptopodium, Cryptotheca, Ctenidiadelphus, Ctenidium, Ctenium, Cupressina, Curvicladium, Curviramea, Cyathophorella, Cyathophorum, Cyclodictyon, Cygniella, Cylicocarpus, Cynodon, Cynodontiella, Cynodontium, Cynontodium, Cyrto-hypnum, Cyrtomnium, Cyrtopodendron, Daltonia, Dasymitrium, Dawsonia, Dendro-hypnum, Dendroalsia, Dendrocyathophorum, Dendrohypopterygium, Dendroligotrichum, Dermatodon, Desmatodon, Desmotheca, Dialytrichia, Diaphanophyllum, Dichelodontium, Dichelyma, Dichodontium, Dicladiella, Dicnemoloma, Dicranella, Dicranodon, Dicranodontium, Dicranoloma, Dicranoweisia, Dicranum, Didymodon, Dimerodontium, Dimorphocladon, Diobelon, Diobelonella, Diphascum, Diphyscium, Diplocomium, Diploneuron, Diplostichum, Discelium, Discophyllum, Dissodon, Distichia, Distichium, Distichophyllidium, Distichophyllum, Ditrichopsis, Ditrichum, Dixonia, Dolichomitra, Dolichomitriopsis, Dolotortula, Donneffia, Donrichardsia, Dorcadion, Dozya, Drepanium, Drepano-hypnum, Drepanocladus, Drepanophyllaria, Drepanophyllum, Drummondia, Dryptodon, Dusenia, DuthieIla, Eccremidium, Echinodiopsis, Echinodium, Echinophyllum, Ectropotheciella, Ectropotheciopsis, Ectropothecium, Eleutera, Elharveya, Elmeriobryum, Elodium, Encalypta, Endotrichella, Endotrichellopsis, Endotrichum, Entodon, Entosthodon, Entosthymenium, Eobruchia, Eohypopterygiopsis, Eoleucodon, Eosphagnum, Ephemerella, Ephemeridium, Ephemeropsis, Ephemerum, Epipterygium, Eremodon, Eriodon, Eriopus, Erpodium, Erythrobarbula, Erythrodontium, Erythrophyllastrum, Erythrophyllopsis, Erythrophyllum, Esenbeckia, Eucamptodontopsis, Eucatagonium, Eucladium, Euephemerum, Eumyurium, Euptychium, Eurhynchiadelphus, Eurhynchiastrum, Eurhynchiella, Eurhynchium, Eurohypnum, Eustichia, Euzygodon, Exodictyon, Exostratum, Exsertotheca, Fabroleskea, Fabronialschyrodon, Fabronidium, Fallaciella, Fauriella, Felipponea, Fiedleria, Fifealsotheciadelphus, Fissidens, Flabeffidium, Fleischerobryum, Floribundaria, Florschuetziella, Flowersia, Fontinalis, Foreauella, Forsstroemia, Frahmiella, Funaria, Funariella, Gammiella, Ganguleea, Garckea, Garovaglia, Gasterogrimmia, Geheebia, Gemmabryum, Georgia, Gertrudia, Gertrudiella, Gigaspermum, Giraldiella, Globulina, Globulinella, Glossadelphus, Glyphomitrium, Glyphomitrium, Glyphothecium, Glyptothecium, Gollania, Gongronia, Goniobryum, Goniomitrium, Gradsteinia, Grimmia, Groutiella, Guembelia, Guerramontesia, Gymnostomiella, Gymnostomum, Gyroweisia, Habrodon, Habrodonlshibaealwatsukiella, Hageniella, Hamatocaulis, Hampeella, Hampeohypnum, Handeliobryum, Haplocladium, Haplodon, Haplodontium, Haplohymenium, Haptymenium, Harpidium, Harpophyllum, Harrisonia, Harveya, Hebantialtatiella, Hedenaesia, Hedenasiastrum, Hedwigia, Hedwigidium, Helicoblepharum, Helicodontiadelphus, Helicodontium, Heliconema, Helicophyllum, Helodium, Hemiragis, Henicodium, Hennediella, Herpetineuron, Herzogiella, Heterocladium, Heterodon, Heterophyllium, Hildebrandtiella, Hilpertia, Himantocladium, Holoblepharum, Holodontium, Holomitriopsis, Holomitrium, Homalia, Homaliadelphus, Homaliodendron, Homaliopsis, Homalotheciella, Homalothecium, Homomallium, Hondaella, Hookeria, Hookeriopsis, Horikawaea, Horridohypnum, Husnotiella, Hyalophyllum, Hydrocryphaealsodrepanium, Hydrogonium, Hydropogon, Hydropogonella, Hygroamblystegium, Hygrodicranum, Hygrohypnella, Hygrohypnum, Hylocomiadelphus, Hylocomiastrum, Hylocomiopsis, Hylocomium, Hymenodon, Hymenodontopsis, Hymenoloma, Hymenostomum, Hymenostyliella, Hymenostylium, Hyocomium, Hyophila, Hyophiladelphus, Hyophilopsis, Hypnella, Hypnites, Hypnobartlettia, Hypnodendron, Hypnum, Hypodontium, Hypopterygium, Imbribryum, Indopottia, Indothuidium, lndusiella, Inouethuidium, Isopterygiopsis, Iso pterygium, Isotheciopsis, Isothecium, Jaegerina, Jaegerinopsis, Jaffueliobryum, Juratzkaeella, Kiaeria, Kindbergia, Kingiobryum, Kleioweisiopsis, Koponenia, Kurohimehypnum, Lamprophyllum, Leersia, Leiodontium, Leiomela, Leiomitrium, Leiotheca, Lembophyllum, Lepidopilidium, Lepidopilum, Leptangium, Leptobarbula, Leptobryum, Leptocladiella, Leptocladium, Leptodictyum, Leptodontiella, Leptodontiopsis, Leptodontium, Leptohymenium, Leptophascum, Leptopterigynandrum, Leptostomopsis, Leptostomum, Leptotheca, Leptotrichella, Leptotrichum, Lepyrodon, Lepyrodontopsis, Leratia, Leratiella, Lescuraea, Leskea, Leskeadelphus, Leskeella, Leskeodon, Leskeodontopsis, Lesquereuxia, Leucobryum, Leucodon, Leucodontella, Leucolepis, Leucoloma, Leucomium, Leucoperichaetium, Leucophanella, Leucophanes, Levierella, LimbeIla, Limnobium, Limprichtia, Lindbergia, Lindigia, Loeskeobryum, Loeskypnum, Loiseaubryum, Looseria, Lophiodon, Lopidium, Lorentzia, Lorentziella, Loxotis, Ludorugbya, Luisierella, Lyeffia, Macgregorella, Macouniella, Macro coma, Macrodictyum, Macrohymenium, Macromitrium, Macrosporiella, Macrothamniella, Macrothamnium, Mamillariella, Mandoniella, Maschalanthus, Maschalocarpus, Mastopoma, Matteria, Meesia, Meiotheciella, Meiotheciopsis, Meiothecium, Meiotrichum, Merceya, Merceyopsis, Mesochaete, Mesonodon, Mesotus, Metadistichophyllum, Metaneckera, Meteoridium, MeteoricIla, Meteoriopsis, Meteorium, Metzlerella, Metzleria, Micralsopsis, Microbryum, Microcampylopus, Microcrossidium, Microctenidium, Microdus, Microeurhynchium, Micromitrium, Micropoma, Microthamnium, Microtheciella, Microthuidium, Miehea, Mielichhoferia, Mildea, Mildeella, Mironia, Mitrobryum, Mittenia, Mittenothamnium, Mitthyridium, Miyabea, Mniadelphus, Mniobryum, Mniodendron, Mniomalia, Mnium, Moenkemeyera, Molendoa, Moffia, Morinia, Moseniella, Muelleriella, Muellerobryum, Muscoflorschuetzia, Muscoherzogia, Myrinia, Myurella, Myuriopsis, Myurium, Myuroclada, Nanobryum, Nanomitriopsis, Nanomitrium, Neckera, Neckeradelphus, Neckerites, Neckeropsis, Nematocladia, Neobarbella, Neocardotia, Neodicladiella, Neodolichomitra, Neohyophila, Neolescuraea, Neolindbergia, Neomacounia, Neomeesia, Neonoguchia, Neophoenix, Neorutenbergia, Neosharpiella, Niphotrichum, Nobregaea, Nogopterium, Noguchiodendron, Notoligotrichum, Ochiobryum, Ochrobryum, Ochyraea, Octodiceras, Oedicladium, Oedipodiella, Oedipodium, Okamuraea, Oligotrichum, Oncophorus, Oreas, Oreoweisia, Orontobryum, Orthoamblystegium, Orthodicranum, Orthodon, Orthodontium, Orthodontopsis, Orthogrimmia, Orthomitrium, Orthomnion, Orthomniopsis, Orthopus, Orthopyxis, Orthorrhynchidium, Orthorrhynchium, Orthostichella, Orthostichidium, Orthostichopsis, Orthotheciella, Orthothecium, Orthothecium, Orthothuidium, Orthotrichum, Osterwaldiella, Oticodium, Oxyrrhynchium, Oxystegus, Pachyneuropsis, Pachyneurum, Palaeocampylopus, Palamocladium, Palisadula, Paludella, Palustriella, Panckowia, Pancovia, Papillaria, Papiffidiopsis, Paraleucobryum, Paramyurium, Pararhacocarpus, Parisia, Pelekium, Pendulothecium, Pentastichella, Penzigiella, Peromnion, Pharomitrium, Phasconica, Phascopsis, Phascum, Philibertiella, Philonotis, Philophyllum, Photinophyllum, Phyllodon, Phyllodrepanium, Phyllogonium, Physcomitrella, Physcomitrium, Physedium, Picobryum, Pictus, Piloecium, Pilopogon, Pilopogonella, Piloseriopus, Pilotrichella, Pilotrichidium, Pilotrichum, PinnateIla, Pirea, Pireella, Plagiobryoides, Plagiobryum, Plagiomnium, Plagiopus, Plagioracelopus, Plagiothecium, Plasteurhynchium, Platydictya, Platygyriella, Platygyrium, Platyhypnidium, Platyhypnum, Platyloma, Platylomella, Platyneuron, Plaubelia, Pleuriditrichum, Pleuridium, Pleurochaete, Pleurophascum, Pleuropus, Pleurorthotrichum, Pleuroweisia, Pleurozium, Pleurozygodon, Pocsiella, Podperaea, Poecilophyllum, Pogonatum, Pohlia, PoIla, Polymerodon, Polypodiopsis, Polytrichadelphus, Polytrichastrum, Polytrichites, Polytrichum, Porothamnium, Porotrichella, Porotrichodendron, Porotrichopsis, Porotrichum, Potamium, Pottia, Pottiopsis, Poweffia, Poweffiopsis, Pringleella, Prionidium, Prionodon, Pseudatrichum, Pseudephemerum, Pseudisothecium, Pseudoamblystegium, Pseudobarbella, Pseudobraunia, Pseudobryum, Pseudocaffiergon, Pseudocampylium, Pseudochorisodontium, Pseudocrossidium, Pseudodimerodontium, Pseudodistichium, Pseudoditrichum, Pseudohygrohypnum, Pseudohyophila, Pseudohypnella, Pseudoleskea, Pseudoleskeella, Pseudoleskeopsis, Pseudopiloecium, Pseudopilotrichum, Pseudopleuropus, Pseudopohlia, Pseudopterobryum, Pseudoracelopus, Pseudorhynchostegiella, Pseudoscleropodium, Pseudosymblepharis, Pseudotimmiella, Pseudotrismegistia, Psilopilum, Pterigynandrum, Pterobryella, Pterobryidium, Pterobryon, Pterobryopsis, Pterogoniadelphus, Pterogonidium, Pterogoniella, Pterogonium, Pterygoneurum, Pterygophyllum, Ptilium, Ptychodium, Ptychomitriopsis, Ptychomitrium, Ptychomniella, Ptychomnion, Ptychostomum, Puiggaria, Puiggariella, Puiggariopsis, Pulchrinodus, Pungentella, Purseffia, Pylaisia, Pylaisiadelpha, Pylaisiella, Pylaisiobryum, Pyramidula, Pyramitrium, Pyromitrium, Pyrrhobryum, Quaesticula, Racelopodopsis, Racelopus, Racomitrium, Racopilum, Radulina, Raineria, Rauia, Rauiella, Regmatodon, Reimersia, Remyella, Renauldia, Rhabdodontium, Rhabdoweisia, Rhacocarpus, Rhacopilopsis, Rhamphidium, Rhaphidorrhynchium, Rhaphidostegium, Rhaphidostichum, Rhexophyllum, Rhizofabronia, Rhizogonium, Rhizohypnum, Rhizomnium, Rhizopelma, Rhodobryum, Rhyncho-hypnum, Rhynchostegiella, Rhynchostegiopsis, Rhynchostegium, Rhystophyllum, Rhytidiadelphus, Rhytidiastrum, Rhytidiopsis, Rhytidium, Richardsiopsis, Rigodiadelphus, Roeffia, Rosulabryum, Rottleria, Rutenbergia, Saelania, Sagenotortula, Sainthelenia, Saitoa, Saitobryum, Saitoella, Sanionia, Saproma, Sarconeurum, Sarmentypnum, Sasaokaea, Sauloma, Scabridens, Schimperella, Schimperobryum, Schistidium, Schistomitrium, Schistophyllum, Schistostega, Schizomitrium, Schizymenium, Schliephackea, Schlotheimia, Schraderobryum, Schwetschkea, Schwetschkeopsis, Sciadocladus, Sciaromiella, Sciaromiopsis, Sciaromium, Sciuro-hypnum, Sclerodontium, Sclerohypnum, Scleropodiopsis, Scleropodium, Scopelophila, Scorpidium, Scorpiurium, Scouleria, Scytalina, Sebillea, Sehnemobryum, Sekra, Seligeria, Sematophyffites, Sematophyllum, Semibarbula, Serpoleskea, Serpotortella, SharpieIla, Shevockia, Sigmatella, Simophyllum, Simplicidens, Sinocaffiergon, Sinskea, Skitophyllum, Skottsbergia, Solmsia, Solmsiella, Sorapilla, Sphaerangium, Sphaerocephalus, Sphaerothecium, Sphagnum, Spiridentopsis, Spirula, Splachnum, Sporledera, Spruceella, Squamidium, Stableria, Steerecleus, Steereobryon, Stegonia, Stellariomnium, Stenocarpidiopsis, Stenodesmus, Stenodictyon, Stenotheciopsis, Stenothecium, Steppomitra, Stereodon, Stereodontopsis, Stereohypnum, Steyermarkiella, Stokesiella, Stonea, Stoneobryum, Straminergon, Straminergon, Streblopilum, Streblotrichum, Streimannia, Strephedium, Streptocalypta, Streptocolea, Streptopogon, Streptotrichum, Stroemia, Strombulidens, Struckia, Struckia, Stylocomium, Swartzia, Symblepharis, Symphyodon, Symphysodon, Symphysodontella, Syntrichia, Syrrhopodon, Systegium, Taiwanobryum, Takakia, Tamariscella, Taxicaulis, Taxiphyllum, Taxithelium, Tayloria, Teichodontium, Teniolophora, Teretidens, Terrestria, Tetracoscinodon, Tetraphidopsis, Tetraphis, Tetraplodon, Tetrapterum, Tetrastichium, Tetrodontium, Thamniella, Thamniopsis, Thamnium, Thamnobryum, Thamnomalia, Thelia, Thiemea, Thuidiopsis, Thuidium, Thyridium, Thysanomitrion, Timmia, Timmiella, Timokoponenia, Toloxis, Tomentypnum, TorteIla, Tortula, Touwia, Touwiodendron, Trachybryum, Trachycarpidium, Trachycladiella, Trachycystis, Trachyloma, Trachymitrium, Trachyodontium, Trachyphyllum, Trachythecium, Trachyxiphium, Trematodum, Trichodon, Trichodontium, Tricholepis, Trichosteleum, Trichostomopsis, Trichostomum, Tridontium, Trigonodictyon, Tripterocladium, Triquetrella, Trismegistia, Tristichium, Tuerckheimia, Uleastrum, Uleobryum, Ulota, Unclejackia, Valdonia, Venturiella, Verrucidens, Vesicularia, Vesiculariopsis, Vetiplanaxis, Viridivellus, Vittia, Voitia, Vroffikheidia, Warburgiella, Wardia, Warnstorfia, Webera, Weisiodon, Weisiopsis, Weissia, Weissiodicranum, Werneriobryum, Weymouthia, Wijkia, Wildia, Wiffia, Wilsoniella, Yunnanobryon, Zelometeorium, Zygodon, Zygotrichia.

According to another preferred embodiment of the method according to the invention, the, one, several or all plants are one or more hornwort(s) selected from the group consisting of the genera: Anthoceros, Dendroceros, Folioceros, Hattorioceros, Leiosporoceros, Megaceros, Mesoceros, Nothoceros, Notothylas, Paraphymatoceros, Phaeoceros, Phaeomegaceros, Phymatoceros, Sphaerosporoceros.

Preferably, the substrate comprises one or more material(s) selected from the group consisting of sand, soil, humus, crushed stone, gravel, clay, silt, sawdust, paper, cardboard, chipboard, softwood, limestone and coal, more preferably the substrate comprises one or more material(s) selected from the group consisting of soil, humus, crushed stone, gravel, clay, silt, sawdust, paper, cardboard, chipboard, softwood, limestone and coal,

and/or

preferably the substrate is an area of land selected from the group consisting of a garden area, a joint area of paving blocks and stones, an arable land, an orchard, a vineyard area, a tree nursery area, a park, a part of a developed land or urban area, an unpaved road, a footpath, a railway line, an industrially used area and an area between and before said areas of land, more preferably the substrate is an area of land selected from the group consisting of a garden area, an arable land, an orchard, a vineyard area, a tree nursery area, a park, a part of a developed land or urban area, an unpaved road, a footpath, a railway line, an industrially used area and an area between and before said areas of land.

Preferably, the substrate is selected from the group consisting of organic and inorganic materials, preferably of biogenic and/or anthropogenic origin, further preferably metamorphic, sedimentary and magmatic stone and derivatives and mixtures thereof.

Most preferably, the substrate is selected from the group consisting of sand, soil, preferably land soil, sifted land soil and plant soil, humus, crushed stone, gravel, clay, silt, sawdust, paper, cardboard, chipboard, softwood, limestone, coal and mixtures thereof.

A method as described above is preferred, wherein the substrate comprises one or more material(s) selected from the group consisting of materials, which are described by one or more of the sub groups according to H. Strunz and E. H. Nickel, Strunz Mineralogical Tables, 2001, 9th edition:
(i) Elements (including all sub groups), e.g., but not exclusive: Carbon, silicon, aluminium, nitrogen, oxygen, phosphorus, hydrogen, sodium, potassium, magnesium, calcium;
(ii) Sulfides and sulfosalts (incl. all sub groups), e.g., but not exclusive: Chalkopyrite, galenite, pyrite;
(iii) Halides (incl. all sub groups), e.g., but not exclusive: Fluoride, chlorides, bromides;
(iv) Oxides, hydroxides and arsenites (incl. all sub groups), e.g., but not exclusive: Silicon oxide, aluminium oxide, magnesium oxide, iron oxide, calcium hydroxide;
(v) Carbonates and nitrates (incl. all sub groups), e.g., but not exclusive: Calcite, magnesium carbonate, sodium nitrate, potassium nitrate, calcium nitrate;
(vi) Borates (incl. all sub groups), e.g., but not exclusive: Borax;
(vii) Sulfates, chromates, molybdates and tungstates (incl. all sub groups), e.g., but not exclusive: Calcium sulfate;
(viii) Phosphate, arsenate, vanate (incl. all sub groups), e.g., but not exclusive: Monazite;
(ix) Silicates, germanates (incl. all sub groups), e.g., but not exclusive: Olivin, topas, muskovit, talcum, cement, microsilica;
(x) Organic compounds (incl. all sub groups), e.g., but not exclusive: Humic substances, lignin and derivatives and oxidation products thereof, compost material.

Preferably, the substrate comprises one or more material(s) selected from the group consisting of mixtures of one or more of the above-mentioned materials (i) to (x) as well as substances and mixtures with biogenic and/or anthropogenic origin, in which plant growth is possible, e.g. but not exclusive: Cable sand, fine sand, natural sand, quartz sand, crystal quartz sand, bird sand, gravel sand, joint sand, crushed sand, quartz flour, mineral mixture (stone, chippings, gravel), triple hell, savonniere stone flour, plaster, loess, topsoil, limestone crushed sand, limestone flour, calcium carbonate (incl. polymorphs, derivatives and mixtures, as well as naturally based (GCC ground calcium carbonate) as well as synthetic PCC (precipitated calcium carbonate)), talc, dolomite, white lime (hydrate), trass, cements and mixtures thereof, microsilica, chalk (mixture), marble, pearlite, overburden, heap material, hematite, red chalk, magnesite, iron ore, steatite, soapstone, kaolin, marl, alumina, attapulgite, clay minerals, bentonite, zeolite, (calco)stucco, gravel, glass powder, aluminium oxide, aluminium hydroxide, magnesium oxide, calcium oxide, calcium hydroxide, magnesite, slate powder, pumice stone, cristobalite (sand), roman cement, bauxite, pyrites, sphalerites, silicates, oxides, carbonates, wood (chips), mulch, alluvial soil, laterite, hematite, ash (wood ash, fly ash, bone ash), (pig) farm soils, LUFA standard soils (see e.g. http://www.lufa-speyer.de/) or mixtures thereof.

A method according to the invention is preferred, wherein the substrate is an area of land selected from the group consisting of a garden area, a joint area of terraces or entrances and exits, an arable area, a farmland, an orchard, a vineyard area, a tree nursery area, a park, a part of a developed land or urban area, a road, a street, a footpath, a railway line, an industrially used area, an area between the before mentioned areas, preferably joints with a width of over 1 mm, preferably over 0.5 cm, more preferably over 1 cm, more preferably over 2 cm, more preferably over 5 cm, most preferably over 10 cm.

Depending on the properties of the substrate to be treated as identified in step (a) of the method according to the invention, it may be advantageous to add one or more of the hardeners and/or performance modifiers as defined above (or one or more of the component(s) (a), (b) and/or (c) of the mixture as defined herein provided in step (b)) to the substrate before carrying out step (c) of the method (or applying and/or introducing the remaining component(s) (a), (b) and/or (c) of the mixture as defined herein provided in step (b)), for example to improve the reactivity of the substrate with the mixture applied and/or introduced in step (c) or formed during step (c). This advantageously leads to the formation of particularly hard and/or flexible and/or stable hardened layer(s) or area(s) in step (d), which suppress plant, preferably weed, growth particularly effectively.

Preferably, hardeners (component (c) of the mixture), if present, may be pre-applied to the substrate when liquid alkali silicates are used as component (a) of the mixture. Moreover, they can also be mixed with one or more powdered alkali silicate(s) and co-applied to the substrate surface with a significant gain in the obtained weed penetration resistance of the treated substrate.

The method according to the invention makes it possible, for example, to close and/or harden joint surfaces of terraces, entrances, exits, driveways, roads or footpaths or open areas with the aid of the mixture as defined herein, thus effectively suppressing the growth of plants, preferably weeds, in/on these substrates.

It is preferred to apply the method according to the invention to plant, preferably weed, suppression in agriculture, for example on farmland used for grain, vegetable or fruit farming.

Advantageously, with the method according to the invention, it is possible to apply small amounts of the mixture as defined herein while still achieving efficient plant, preferably weed, growth prevention or reduction.

A preferred embodiment relates to a method according to the invention as described herein, wherein the one or more hardened layer(s) or area(s) formed in step (d) allow the (further) growth of wanted plants, but prevent or reduce the growth of (new) weeds.

Preferably, the lateral dimensions of the substrate are greater than 0.5 cm, preferably greater than 1 cm, more preferably greater than 2 cm, most preferably greater than 5 cm, respectively.

Preferably, the substrate hardened by the method according to the invention is a garden, a garden bed, a walking path or an area next to a road or a field.

Preferably, the lateral dimensions of the substrate are greater than 10 cm, preferably greater than 50 cm, more preferably greater than 1 m, more preferably greater than 5 m, most preferably greater than 10 m, respectively.

Preferably, the hardening of the substrate by the method according to the invention leads to the formation of a hardened layer on/in the substrate with a layer thickness of greater than 0 to 100 mm, preferably of 1 to 50 mm, preferably of 2 to 25 mm, most preferably of 3 to 10 mm.

Preferably, the amount of mixture applied to the substrate or introduced into the substrate in step (c) is less than 400 g/m², preferably less than 300 g/m², more preferably less than 200 g/m², most preferably less than 100 g/m².

This means that in case the steps (b) to (d) of the method are repeated, the defined amount relates to the amount of mixture applied to the substrate or introduced into the substrate in each step (c) that was carried out, respectively.

Another aspect of the invention relates to a mixture for preventing or reducing plant, preferably weed, growth comprising or consisting of the following components
(a) one or more alkali silicates selected from the group consisting of lithium silicate, sodium silicate, potassium silicate, rubidium silicate, caesium silicate and mixtures thereof,
   wherein the modulus M of the one or more alkali silicates is >1.7, preferably >2.0, more preferably >2.5, most preferably >3.0, respectively,
(b) two or more performance modifiers,
   wherein two or the, several or all performance modifier(s) is/are independently selected from the group consisting of
   (i) (bio)polymers selected from the group consisting of
      cellulose and derivatives thereof, starch and derivatives thereof, lignin and derivatives thereof, preferably lignin sulfonates, kraft-lignins and lignin carboxylates, pectins and derivatives thereof, xanthan and derivates thereof, guarethers and derivatives thereof;
      chitin and derivatives thereof, algin and derivatives thereof, chitosan and derivatives thereof, cylcodextrins and derivatives thereof, dextrins and
      natural glues, hydrogel builders, plant lime, latex, rubber and derivatives thereof;
      proteins and peptides comprising one or more of the amino acids selected from the group consisting of alanin, glycin, lysin, asparagin, glutamin, glutamate and non-proteinogenic amino acids;
      industrial substances, residual polymeric substances and industrial by-products selected from the group consisting of industrial effluents, preferably corn steep liquor, lactose mother liquor, protein lysates and molasses, vegetable meals, preferably corn gluten meal, pea meal, fruit meals and protein wastes, preferably from yeast production, meat production, fruit production, vegetable production, egg production, dairy industry and papermaking;
      starch ethers, starch esters, starch carboxylates, cellulose esters, cellulose ethers, cellulose carboxylates, yeasts and derivatives or extracts thereof;
      liquid or dried polymer dispersions or polymers comprising organic acids, preferably sulfonic acids, carboxylic acids, peroxy carboxylic acids and thio carboxylic acids and salts thereof, sulfoxides, cyanates, thiocyanates, esters, ethers, thio ethers, oxides, thio oxides, amines, imines, hydrazines, hyrazones, amids, sulfates, nitriles, aldehydes, thio aldehydes, ketons, thioketons, oximes, alkohols, thiols, radicals, halogens, silanes, siloxanes, phosphates, phosponates, alkyls, allyls, aryls and derivatives thereof, wherein preferably the polymer(s) is/are biodegradable;
   (ii) (poly)saccharides, extracellular substances and derivatives thereof selected from the group consisting of (poly)saccarides comprising lactose, glucose, fructose, saccharose and/or galactose, and microbial exopolysaccharides, preferably comprising lactose, saccharose, glucose, glucosamine, mannose, glycerin, gluconate, fructose and/or inulin;
   (iii) organic acids and derivatives thereof, preferably selected from the group consisting of monocarboxylic acids, preferably formic acid, acetic acid, propionic acid, butyric acid, benzoic acid and salicylic acid, dicarboxylic acids, preferably oxalic acid, malonic acid, succinic acid, glutaric acid, adipic acid and maleic acid, fatty acids, keto acids, preferably pyruvic acid and acetoacetic acid, fruit acids, preferably malic acid and tartaric acid, hydroxy acids, preferably lactic acid, alpha hydroxy acids and beta hydroxy acids, tricarboxylic acids, preferably citric acid, more preferably carboxylates and esters of the before mentioned;
   (iv) amino acids and derivatives thereof, preferably selected from the group consisting of alanin, glycine, lysine, glutamine, glutamate, and non-proteinogenic amino acids, preferably esters and amides thereof;
   (v) viable microorganisms, preferably bacteria capable of forming polymers, non-viable microorganisms and parts thereof;
   (vi) chemical and natural herbicides; fungicides; molluscicides; insecticides; emulsifiers; thixotropic agents;
(c) one or more hardeners,
   wherein one or the, several or all hardener(s) is/are selected from the group consisting of
   (vii) inorganic salt(s) selected from the group consisting of alkali salts, earth alkali salts, metal salts and transition metal salts, preferably calcium, magnesium, aluminum and iron salts, more preferably calcium carbonate, calcium hydrogen carbonate, calcium cyanamide, calcium chloride, calcium hydroxide, calcium sulfate, magnesium carbonate, magnesium hydrogen carbonate, magnesium cyanamide, magnesium chloride, magnesium sulfate, aluminum sulfate, iron chloride, iron sulfate, and phosphates and derivatives thereof;
   and/or
   (viii) inorganic acid(s), preferably sulfuric acid, hydrogen halides, nitric acid and phosphoric acid;
   and/or
   (ix) inorganic binders selected from the group consisting of cement, preferably silicate cement, aluminate cement, magnesia cement and phosphate cement, calcium sulfate, preferably gypsum, calcium oxide and phosphate binders;
   and/or
   (x) minerals selected from the group consisting of clays, inorganic minerals comprising calcium carbonate and derivatives thereof, calcium alumo silicates, microsilica, aluminiumoxide, kaolin, bentonite and expanded glass granules.

A preferred embodiment relates to a mixture for preventing or reducing plant, preferably weed, growth comprising or consisting of the following components
(a) one or more alkali silicates selected from the group consisting of lithium silicate, sodium silicate, potassium silicate, rubidium silicate, caesium silicate and mixtures thereof,
   wherein the modulus M of the one or more alkali silicates is >1.7, preferably >2.0, more preferably >2.5, most preferably >3.0, respectively,
(b) two or more performance modifiers,
   wherein two or the, several or all performance modifier(s) is/are independently selected from the group consisting of
   (i) (bio)polymers selected from the group consisting of
      cellulose and derivatives thereof, starch and derivatives thereof, lignin and derivatives thereof, preferably lignin sulfonates, kraft-lignins and lignin carboxylates, pectins and derivatives thereof, xanthan and derivates thereof, guarethers and derivatives thereof;
      chitin and derivatives thereof, algin and derivatives thereof, chitosan and derivatives thereof, cylcodextrins and derivatives thereof, dextrins and natural glues, hydrogel builders, plant lime, latex, rubber and derivatives thereof;
      proteins and peptides comprising one or more of the amino acids selected from the group consisting of alanin, glycin, lysin, asparagin, glutamin, glutamate and non-proteinogenic amino acids;
      industrial substances, residual polymeric substances and industrial by-products selected from the group consisting of industrial effluents, preferably corn steep liquor, lactose mother liquor, protein lysates and molasses, vegetable meals, preferably corn gluten meal, pea meal, fruit meals and protein wastes, preferably from yeast production, meat production, fruit production, vegetable production, egg production, dairy industry and papermaking;
      starch ethers, starch esters, starch carboxylates, cellulose esters, cellulose ethers, cellulose carboxylates, yeasts and derivatives or extracts thereof;
      liquid or dried polymer dispersions or polymers comprising organic acids, preferably sulfonic acids, carboxylic acids, peroxy carboxylic acids and thio carboxylic acids and salts thereof, sulfoxides, cyanates, thiocyanates, esters, ethers, thio ethers, oxides, thio oxides, amines, imines, hydrazines, hyrazones, amids, sulfates, nitriles, aldehydes, thio aldehydes, ketons, thioketons, oximes, alkohols, thiols, radicals, halogens, silanes, siloxanes, phosphates, phosponates, alkyls, allyls, aryls and derivatives thereof, wherein preferably the polymer(s) is/are biodegradable;
   (ii) (poly)saccharides, extracellular substances and derivatives thereof selected from the group consisting of (poly)saccarides comprising lactose, glucose, fructose, saccharose and/or galactose, and microbial exopolysaccharides, preferably comprising lactose, saccharose, glucose, glucosamine, mannose, glycerin, gluconate, fructose and/or inulin;
   (iii) organic acids and derivatives thereof, preferably selected from the group consisting of monocarboxylic acids, preferably formic acid, acetic acid, propionic acid, butyric acid, benzoic acid and salicylic acid, dicarboxylic acids, preferably oxalic acid, malonic acid, succinic acid, glutaric acid, adipic acid and maleic acid, fatty acids, keto acids, preferably pyruvic acid and acetoacetic acid, fruit acids, preferably malic acid and tartaric acid, hydroxy acids, preferably lactic acid, alpha hydroxy acids and beta hydroxy acids, tricarboxylic acids, preferably citric acid, more preferably carboxylates and esters of the before mentioned;
   (iv) amino acids and derivatives thereof, preferably selected from the group consisting of alanin, glycine, lysine, glutamine, glutamate, and non-proteinogenic amino acids, preferably esters and amides thereof;
   (v) viable microorganisms, preferably bacteria capable of forming polymers, non-viable microorganisms and parts thereof;
   (vi) chemical and natural herbicides; fungicides; molluscicides; insecticides; emulsifiers; thixotropic agents;
(c) one or more hardeners,
   wherein one or the, several or all hardener(s) is/are selected from the group consisting of
   (vii) inorganic salt(s) selected from the group consisting of alkali salts, earth alkali salts, metal salts and transition metal salts, preferably calcium, magnesium, aluminum and iron salts, more preferably calcium carbonate, calcium hydrogen carbonate, calcium cyanamide, calcium chloride, calcium hydroxide, calcium sulfate, magnesium carbonate, magnesium hydrogen carbonate, magnesium cyanamide, magnesium chloride, magnesium sulfate, aluminum sulfate, iron chloride, iron sulfate, and phosphates and derivatives thereof;
   and/or
   (viii) inorganic acid(s), preferably sulfuric acid, hydrogen halides, nitric acid and phosphoric acid;
   and/or
   (ix) inorganic binders selected from the group consisting of cement, preferably silicate cement, aluminate cement, magnesia cement and phosphate cement, calcium sulfate, preferably gypsum, calcium oxide and phosphate binders.

A particularly preferred embodiment relates to a mixture for preventing or reducing plant, preferably weed, growth comprising or consisting of the following components
(a) one or more alkali silicates selected from the group consisting of lithium silicate, sodium silicate, potassium silicate, rubidium silicate, caesium silicate and mixtures thereof,
   wherein the modulus M of the one or more alkali silicates is >1.7, preferably >2.0, more preferably >2.5, most preferably >3.0, respectively,
(b) two or more performance modifiers,
   wherein two or the, several or all performance modifier(s) is/are independently selected from the group consisting of
   (i) (bio)polymers selected from the group consisting of
      cellulose and derivatives thereof, starch and derivatives thereof, lignin and derivatives thereof, preferably lignin sulfonates, kraft-lignins and lignin carboxylates, pectins and derivatives thereof, xanthan and derivates thereof, guarethers and derivatives thereof;
      chitin and derivatives thereof, algin and derivatives thereof, chitosan and derivatives thereof, cylcodextrins and derivatives thereof, dextrins and derivatives thereof;
      natural glues, hydrogel builders, plant lime, latex, rubber and derivatives thereof;
      proteins and peptides comprising one or more of the amino acids selected from the group consisting of alanin, glycin, lysin, asparagin, glutamin, glutamate and non-proteinogenic amino acids;
      industrial substances, residual polymeric substances and industrial by-products selected from the group consisting of industrial effluents, preferably corn steep liquor, lactose mother liquor, protein lysates and molasses, vegetable meals, preferably corn gluten meal, pea meal, fruit meals and protein wastes, preferably from yeast production, meat production, fruit production, vegetable production, egg production, dairy industry and papermaking;
      starch ethers, starch esters, starch carboxylates, cellulose esters, cellulose ethers, cellulose carboxylates, yeasts and derivatives or extracts thereof;
      liquid or dried polymer dispersions or polymers comprising organic acids, preferably sulfonic acids, carboxylic acids, peroxy carboxylic acids and thio carboxylic acids and salts thereof, sulfoxides, cyanates, thiocyanates, esters, ethers, thio ethers, oxides, thio oxides, amines, imines, hydrazines, hyrazones, amids, sulfates, nitriles, aldehydes, thio aldehydes, ketons, thioketons, oximes, alkohols, thiols, radicals, halogens, silanes, siloxanes, phosphates, phosponates, alkyls, allyls, aryls and derivatives thereof, wherein preferably the polymer(s) is/are biodegradable;
   (ii) (poly)saccharides, extracellular substances and derivatives thereof selected from the group consisting of (poly)saccarides comprising lactose, glucose, fructose, saccharose and/or galactose, and microbial exopolysaccharides, preferably comprising lactose, saccharose, glucose, glucosamine, mannose, glycerin, gluconate, fructose and/or inulin;
   (iii) organic acids and derivatives thereof, preferably selected from the group consisting of monocarboxylic acids, preferably formic acid, acetic acid, propionic acid, butyric acid, benzoic acid and salicylic acid, dicarboxylic acids, preferably oxalic acid, malonic acid, succinic acid, glutaric acid, adipic acid and maleic acid, fatty acids, keto acids, preferably pyruvic acid and acetoacetic acid, fruit acids, preferably malic acid and tartaric acid, hydroxy acids, preferably lactic acid, alpha hydroxy acids and beta hydroxy acids, tricarboxylic acids, preferably citric acid, more preferably carboxylates and esters of the before mentioned;
   (iv) amino acids and derivatives thereof, preferably selected from the group consisting of alanin, glycine, lysine, glutamine, glutamate, and non-proteinogenic amino acids, preferably esters and amides thereof;
   (v) viable microorganisms, preferably bacteria capable of forming polymers, non-viable microorganisms and parts thereof;
   (vi) chemical and natural herbicides; fungicides; molluscicides; insecticides; emulsifiers; thixotropic agents;
(c) one or more hardeners,
   wherein one or the, several or all hardener(s) is/are selected from the group consisting of
   (vii) inorganic salt(s) selected from the group consisting of alkali salts, earth alkali salts, metal salts and transition metal salts, preferably calcium, magnesium, aluminum and iron salts, more preferably calcium carbonate, calcium hydrogen carbonate, calcium cyanamide, calcium chloride, calcium hydroxide, calcium sulfate, magnesium carbonate, magnesium hydrogen carbonate, magnesium cyanamide, magnesium chloride, magnesium sulfate, aluminum sulfate, iron chloride, iron sulfate, and phosphates and derivatives thereof;
   and/or
   (viii) inorganic acid(s), preferably sulfuric acid, hydrogen halides, nitric acid and phosphoric acid.

Preferably, in a mixture according to the invention, at least one of the two or more performance modifiers of component (b) is a (bio)polymer.

More preferably, in a mixture according to the invention, at least two of the two or more performance modifiers of component (b) are (bio)polymers.

Most preferably, the one or more alkali silicate(s) of component (a) of the mixture according to the invention have a low particle size (diameter), respectively, preferably exhibiting a maximum in the particle size distribution of below 500 μm, more preferably below 250 μm, most preferably below 125 μm.

Another preferred embodiment relates to a mixture according to the invention, wherein the mixture is present in liquid form, as a gel, paste, powder, granulate or aggregate or intermediate forms thereof (as defined above).

Another preferred embodiment relates to a mixture according to the invention, wherein component (a) comprises or consists of potassium silicate.

Most preferably, in a mixture according to the invention component (a) consists of potassium silicate.

Preferably, the mixture according to the invention contains a total amount of 10 to 90 wt.-15%, preferably 15 to 85 wt.-%, preferably 20 to 80 wt.-%, more preferably 25 to 75 wt.-%, of component (a), based on the total weight of the mixture.

Preferably, the mixture according to the invention contains a total amount of 10 to 90 wt.-%, preferably 15 to 85 wt.-%, preferably 20 to 80 wt.-%, more preferably 25 to 75 wt.-%, of component (b), based on the total weight of the mixture.

Preferably, the mixture according to the invention contains a total amount of 1 to 70 wt.-%, preferably 2 to 60 wt.-%, preferably 5 to 50 wt.-%, more preferably 10 to 40 wt.-%, of component (c), based on the total weight of the mixture.

Alkali silicates are characterized by the respective molar ratio between silicon dioxide and alkali oxide, which is called modulus M:

M=[SiO₂]/[X₂O]

with [SiO₂] being the molar concentration of silicon dioxide and [X₂O] being the molar concentration of the respective alkali oxide with X=Li, Na, K, Rb or Cs (i.e. [X₂O] stands for the molar concentration of either Li₂O, Na₂O, K₂O, Rb₂O or Cs₂O).

In solid formulations, the molar concentrations can be replaced by the respective numbers of moles n(SiO₂) and n(X₂O), i.e. in solid formulations the modulus M of an alkali silicate may be calculated as follows:

M=n(SiO₂)/n(X₂O)

with X₂O being either Li₂O, Na₂O, K₂O, Rb₂O or Cs₂O.

In case the mixture according to the invention comprises more than one alkali silicate, the modulus M of each alkali silicate contained in component (a) of the mixture is >1.7, preferably >2.0, more preferably >2.5, most preferably >3.0.

What is stated herein for a use according to the invention also applies to a method or mixture according to the invention and vice versa. This applies in particular to (preferred) embodiments of the use according to the invention which correspond to (preferred) embodiments of the method according to the invention or can be derived from these and vice versa. Also, (preferred) embodiments of the use according to the invention correspond to or can be derived from (preferred) embodiments of the mixture according to the invention and vice versa.

The invention will now be described in more detail hereinafter with references to the examples. Unless otherwise stated, all data refer to the weight.

### DRAWINGS

FIG. 1: Degree of efficiency of weed penetration resistance at various time points: 7 days: black bars, 13 days: vertical stripes, 15 days: not filled, 22 days: horizontal stripes, 27 days: fine dots, 34 days: filled with black and white squares. Mixture 1 [K-M-1.7] was used in different dosages, given in the x-axis in grams per square meter. From left to right: 1003 g/m², 825 g/m², 750 g/m², 675 g/m², 600 g/m², 525 g/m², 450 g/m², 375 g/m², 300 g/m², 225 g/m², 150 g/m². Negative values indicate accelerated weed growth. Positive values indicate control of weed growth.

FIG. 2: Degree of efficiency of weed penetration resistance at various time points: 7 days: black bars, 13 days: vertical stripes, 15 days: not filled, 22 days: horizontal stripes, 27 days: fine dots, 34 days: filled with black and white squares. Mixture 2 [Na-M-1.7] was used in different dosages, given in the x-axis in grams per square meter. From left to right: 1003 g/m², 975 g/m², 900 g/m², 825 g/m², 750 g/m², 675 g/m², 600 g/m², 525 g/m², 450 g/m², 375 g/m², 300 g/m², 225 g/m², 150 g/m², 75 g/m². Negative values indicate accelerated weed growth. Positive values indicate control of weed growth.

FIG. 3: Degree of efficiency of weed penetration resistance at various time points: 7 days: black bars, 13 days: vertical stripes, 15 days: not filled, 22 days: horizontal stripes, 27 days: fine dots, 34 days: filled with black and white squares. Mixture 3 [Na-M-2.5] was used in different dosages, given in the x-axis in grams per square meter. From left to right: 1003 g/m², 975 g/m², 900 g/m², 825 g/m², 750 g/m², 675 g/m², 600 g/m², 525 g/m², 450 g/m², 375 g/m², 300 g/m², 225 g/m², 150 g/m², 75 g/m². Negative values indicate accelerated weed growth. Positive values indicate control of weed growth.

FIG. 4: Degree of efficiency of weed penetration resistance at various time points: 7 days: black bars, 13 days: vertical stripes, 15 days: not filled, 22 days: horizontal stripes, 27 days: fine dots, 34 days: filled with black and white squares. Mixture 2 [Na-M-1.7] was used as alkali silicate with 225 g/m². Mixture 6, 7, 8 and 9 were used using 225 g/m² alkali silicate plus the respective hardener and/or performance modifier. Negative values indicate accelerated weed growth. Positive values indicate control of weed growth.

FIG. 5: Degree of efficiency of weed penetration resistance at various time points: 7 days: black bars, 13 days: vertical stripes, 15 days: not filled, 22 days: horizontal stripes, 27 days: fine dots, 34 days: filled with black and white squares, of different application amounts, namely 375 g/m², 250 g/m², 125 g/m², 62.52 g/m² of powdered alkali silicate. A: [Na-M-2.5], B: [Na-M-3.3]. Powders were applied by spreading and activated by water.

FIG. 6: Illustration of mechanical weed prevention. A: The weeds can germinate and grow until they reach the hardened layer. The hardened layer is indicated by the two arrows, where the upper arrow represents the soil surface and the lower arrow indicates the end of the hardened crust. Crust thickness can be adjusted using preferred embodiments of the present invention. B: Weeds grow through cracks within the material. Preferred embodiments of the invention allow the reduction of cracks and, thus, an increased weed penetration resistance. Right sample: [Na-M-3.3] (150 g/m²), middle sample: [Na-M-3.3]+calcium chloride (hardener), left sample: [Na-M-3.3]+nanoparticle seeding material (performance modifier).

FIG. 7: Degree of efficiency of weed penetration resistance at various time points: 7 days: black bars, 13 days: vertical stripes, 15 days: not filled, 22 days: horizontal stripes, 27 days: fine dots, 34 days: filled with black and white squares, using 200 g/m² application rate. A: Use of different formulations based on solid alkali silicate [Na-M-2.5], B: Use of different formulations based on alkali silicate [Na-M-3.3].

FIG. 8: Degree of efficiency of weed penetration resistance at various time points: 7 days: black bars, 13 days: vertical stripes, 15 days: not filled, 22 days: horizontal stripes, 27 days: fine dots, 34 days: filled with black and white squares, using [Na-M-3.3] of different size distributions. A: [Na-M-3.3] having a maximum of the particle size distribution at 80 μm (less than 2% of particles being bigger than 250 μm and less than 40% of particles being below 63 μm). B: [Na-M-3.3] having a maximum of the particle size (diameter) distribution at 125 μm (less than 5% of particles being bigger than 250 μm and less than 15% of particles being smaller than 63 μm). The application rate in grams per square meter is indicated on the x-axis, respectively.

FIG. 9: Outdoor field test in the vineyard. Illustration of three plots one month after application. A: untreated control, B: [Na-M-1.7]−450, C: [Na-M-2.5]−425+CLS−25.

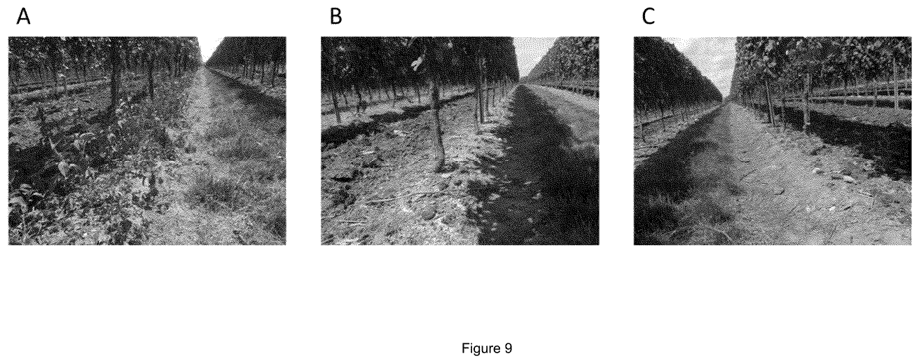

FIG. 10: Illustration of the layer effect of alkali silicate mixtures and absence of chemical interaction on the growing weeds using ribwort plantain and annual meadow grass. A: Layer experiment two weeks after application: The separating layer of gravel is indicated by the two arrows. Seeds were placed in the lower soil layer. The mixture [K-M-3.3]−75+CLS−50+CaCl₂−20+nanoparticle seeding material−5 was used for weed control. The weeds germinated and grew until they reached the hardened layer. B: Layer experiment, control sample three weeks after application. Without the alkali silicate mixture, weeds grew through the surface. C: Sprouted seeds of ribwort plantain after incubation with [K-M-3.3] (20 wt.-%) for 24 hours, washing and storage in a wet and light space two days after the exposure.

### EXAMPLES

### Example 1: Use of Liquid Alkali Silicates or Mixtures to Control Plant Growth

Material and Methods:

The experiment was carried out in transparent plant pots with a volume of 450 cm³ in the laboratory. The application area was 78.5 cm².

The soil substrate was a sifted land soil. Humus (humic soil) was used as a nutrient source for the desired plant.

Humic soil (250 g) was placed in the plastic plant pot. On top of the humic soil, 250 g of sifted land soil was placed. Both soil substrates were free of weed growth prior to the treatment. Both soils contained minimal residues of endemic weed seeds or inflowing seeds. These present seeds were not sufficient for efficient weed growth. Weed sowing was done with 0.2 g Plantago lanceolate (ribwort plantain) and 0.1 g Poa annua (annual meadow grass) per vessel, respectively. For this purpose, the weeds were placed into the top soil layer in a depth of 2-4 mm.

Different alkali silicate solutions were used in this experiment, which are specified below. The application rate per square meter was 3 liters per square meter. The mentioned alkali silicate dosages per square meter were obtained by diluting the highly concentrated alkali silicate stock solutions to the applicable concentration using deionized water. Each dosage in grams per square meter mentioned below refers to the alkali silicate and/or hardener and/or performance modifier dosage per square meter. Water is not included in the mass in gram per square meter.

The mixtures were applied to the soil surface and incubated for two days prior to first wetting. A total of three samples for each mixture was applied to the soil and the results were averaged. All samples were watered every two to three days and the experiment was kept running over at least two months. The samples were exposed to exterior light and in addition to artificial growth light with a 12 h rhythm between day and night cycles. During this period, the minimum temperature was 14.5° C. and the maximum temperature was 28.8° C.

The alkali silicates used are abbreviated by the following code: [Chemical symbol of the alkali cation of the alkali silicate-M-numerical value of the modulus M of the alkali silicate (as defined herein)]. Used chemical symbols are: Li for lithium, Na for sodium, K for potassium, Rb for rubidium, Cs for caesium and Fr for francium. M stands for the modulus (as defined herein). The numerical value of the modulus is typically between 0.5 and 4.0. A sodium silicate of the modulus 4.0, for example, is thus abbreviated as [Na-M-4.0].

Mixture 0 (M0):

Water (control sample)

Mixture 1 (M1):

Potassium silicate with a modulus of 1.7 [K-M-1.7] in various dosages in grams per square meter.

Mixture 2 (M2):

Sodium silicate with a modulus of 1.7 [Na-M-1.7] in various dosages in grams per square meter.

Mixture 3 (M3):

Sodium silicate with a modulus of 2.5 [Na-M-2.5] in various dosages in grams per square meter.

Mixture 4 (M4):

Sodium silicate with a modulus of 3.3 [Na-M-3.3] in various dosages in grams per square meter.

Mixture 5 (M5):

Potassium silicate with a modulus of 3.3 [K-M-3.3] in various dosages in grams per square meter.

Mixture 6 (M6):

225 g/m² Sodium silicate with a modulus of 1.7 [Na-M-1.7]

25 g/m² Calcium chloride

Mixture 7 (M7):

225 g/m² Sodium silicate with a modulus of 1.7 [Na-M-1.7]

25 g/m² Calcium hydroxide

Mixture 8 (M8):

225 g/m² Sodium silicate with a modulus of 1.7 [Na-M-1.7]

12.5 g/m² Nanoparticle seeding material

Mixture 9 (M9):

225 g/m² Sodium silicate with a modulus of 1.7 [Na-M-1.7]

12.5 g/m² Calcium chloride

12.5 g/m² Polyvinyl alcohol (PVOH)

Mixture 10 (M10):

225 g/m² Sodium silicate with a modulus of 3.3 [Na-M-3.3]

25 g/m² Calcium chloride

Mixture 11 (M11):

225 g/m² Sodium silicate with a modulus of 3.3 [Na-M-3.3]

12.5 g/m² Calcium chloride

12.5 g/m² Nanoparticle seeding material

Mixture 12 (M12):

225 g/m² Potassium silicate with a modulus of 3.3 [K-M-3.3]

12.5 g/m² Calcium acetate

Calcium chloride and calcium hydroxide were the hardeners in mixtures M6, M7, M9, M10 and M11. The nanoparticle seeding material and/or the polyvinyl alcohol and/or the calcium acetate were the performance modifiers in mixtures M8, M9 and M11 and M12. Nanoparticle seeding material was a nanosized silica.

The alkali silicates were applied in liquid form. Solid substances (calcium chloride, calcium hydroxide, nanoparticle seeding material, calcium acetate) were added homogeneously to the surface of the soil prior to application of the alkali silicates. Polyvinyl alcohol in M9 was mixed with the alkali silicate in liquid form.

Weed growth was documented on a regular basis, at least once per week. The so-called coverage rate was determined by manual visual assessment of the plant pots at the specified times. The coverage rate describes in percent the area covered by weeds. From this in turn the degree of efficiency according to Abbott was calculated as follows:

Degree of efficiency=[coverage rate control(day x)−coverage rate product(day x)]/10 coverage rate control(day x)*100

An increased degree of efficiency indicates the formation of a layer which is able to hinder weed penetration to the surface.

Variations of the degree of efficiency over 7% are considered relevant for interpretation: e.g. a sample showing 15% and 22% efficiency were treated as not different, whereas samples of 15% and 23% were treated as being different.

Germination of the seeds was examined through the transparent plant pots.

Results:

Due to the high seed amount and the humus below the sifted land soil, the described weed growth test is a stress test mimicking strong weed growth. In all experiments, seeds germinated indicating the viability of the seeds and/or plants.

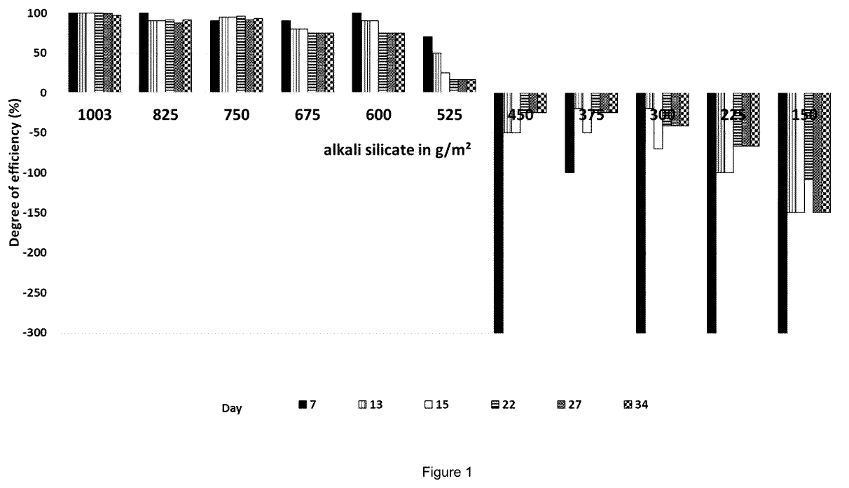

Obtained results indicate that high amounts of alkali silicates prevented the growth of weeds efficiently, respectively (cf. FIGS. 1 to 3). Depending on the cation source and the modulus of the alkali silicate, a dosage exists, where accelerated growth was observed. In the case of Mixture 1 [K-M-1.7] this dosage was 488 g/m². When [K-M-1.7] was applied in lower dosages, weed growth was accelerated with respect to the control, indicated by negative values in the degree of efficiency. This negative value is caused by the degree of coverage being greater than in the respective water control.

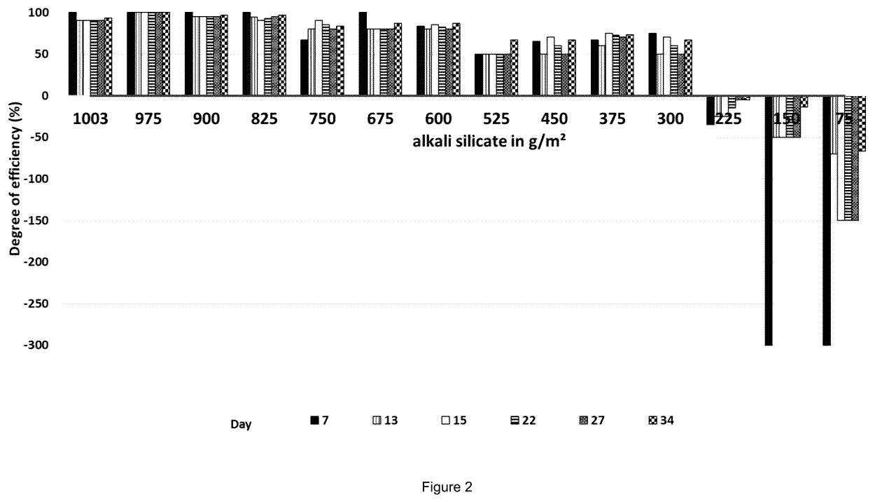

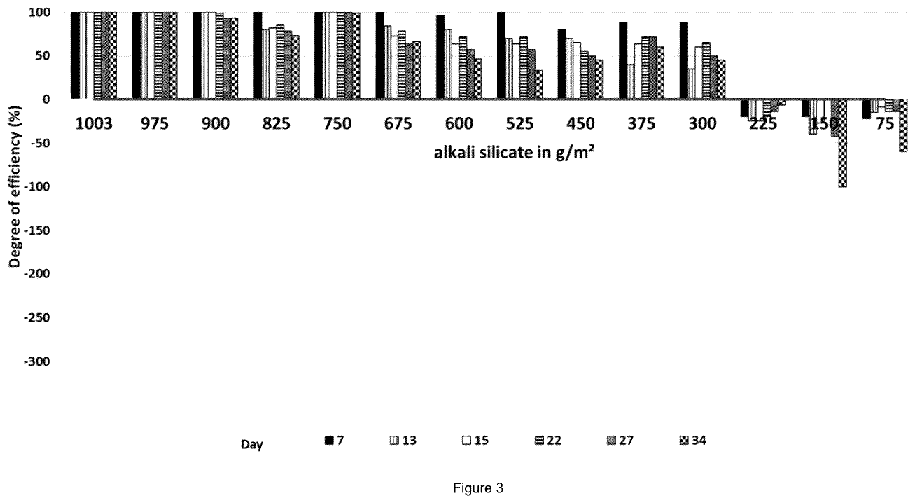

By changing the sodium silicate of a modulus of 1.7 to a sodium silicate of a modulus of 2.5 similar efficiencies were observed. The weed penetration resistance of the formed layer was comparable between these two solutions, as shown in FIGS. 2 and 3. Application rates of 300 g/m² did hinder the penetration of weed, whereas 225 g/m² accelerated weed growth. The tendency to accelerate the growth reduced with increasing modulus.

Mixtures 4 and 5, containing the sodium and potassium silicates of high modulus (M=3.3) did not show effective weed control properties. In the range between 75 g/m² and 740 g/m² no weed penetration resistance was observed.

The penetration of weed was correlated with the mechanical properties of the formed layer. Weeds were able to germinate but penetration through the hardened soil layer was not possible. The alkali silicates harden and form a layer, where weeds do not penetrate.

When weeds reached the surface, they grew through cracks within the soil surface. As a consequence, the homogeneity and crack freeness of the formed layer is important for efficient weed control. The appearance of a hard layer is, however, not a necessity for effective weed growth suppression: A cohesive, elastic behavior of the formed layer, which does not allow weeds to penetrate, was also observed when certain performance modifiers were used. The mechanical hindering of weed growth is characterized by the fact that the seeds show typical germination, as further discussed in example 2.

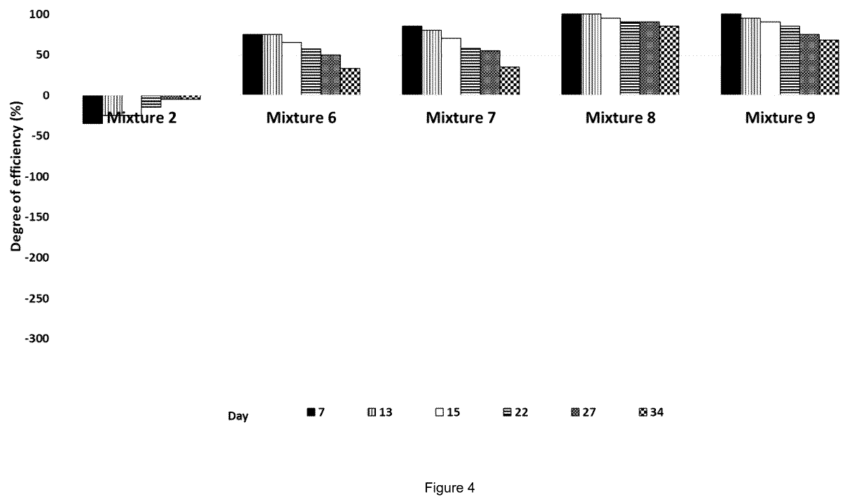

The combination of alkali silicates with a hardener and/or a performance modifier, resulted in more efficient weed penetration resistance and thus, more efficient weed control. In the amounts used, the hardener and/or performance modifier alone did not show influence on weed growth (data not shown). By using one or more hardener(s) and/or one or more performance modifier(s) in combination with the alkali silicate, weed growth was more efficiently controlled. This is shown by the increased degree of efficiency, shown in FIG. 4: Lower application rates (225 g/m²) of the mixtures 6, 7, 8 and 9 resulted in efficient weed penetration resistance, when compared to mixture 2 (compare FIGS. 2 and 4). For example, to reach as efficient weed control as mixtures 6 and 7 (alkali silicate+hardener, 225 g/m²) after 27 days, 525 g/m² of liquid [Na-M-1.7] was necessary. To reach as efficient weed control as mixture 8 and 9 (alkali silicate+performance modifier+optionally a hardener, 225 g/m²) 600 g/m² of [Na-M-1.7] were necessary. The combination of hardener and/or performance modifier with alkali silicates, allows the formation of a weed penetration resistant layer at lower application rates than using alkali silicates alone.

As described above, the use of liquid alkali silicates with high modulus did not show effective weed control (e.g. 0% weed penetration resistance after 27 days), however, a combination of high modulus alkali silicate(s) with hardener and/or performance modifier (M10, M11 and M12) resulted in weed penetration resistance of over 50% after 27 days, indicating that the addition of hardeners and/or performance modifiers is especially necessary when using alkali silicates of higher modulus.

The experiments were kept running over the time reported in the figures. Generally, after 34 days, the performance did not change significantly (change observed was plus/minus 8%), indicating a durable weed prevention effect when a weed preventing layer is formed using a mixture (as defined herein).

### Example 2: Use of Solid Alkali Silicates or Mixtures to Control Plant Growth

Material and Methods:

The experiment was carried out in the laboratory in plant pots with a volume of 450 cm³. The application area was 78.5 cm².

The soil substrate was a sifted land soil. Humus (humic soil) was used as a nutrient source for the desired plant.

Humic soil (250 g) was placed in the plastic plant pot. On top of the humic soil, 250 g of sifted land soil was placed. Both soil substrates were free of weed growth prior to treatment. Both soils contained minimal residues of endemic weed seeds or inflowing seeds. These present seeds were not sufficient for efficient weed growth. Weed sowing was carried out with 0.2 g Plantago lanceolate (ribwort plantain) and 0.1 g Poa annua (annual meadow grass) per vessel, respectively. For this purpose, the weeds were worked into the top soil layer in a depth of 2-4 mm.

Different alkali silicate powders were used in this experiment, which are specified in detail below. Hardeners and/or performance modifiers were added, if applicable. The solid formulations were mixed and then applied homogeneously to the soil surface. Water was applied after the application of the alkali silicate or mixture of alkali silicate and hardener and/or performance modifier to the surface. As a control surface, no substance was added to the soil surface and the control was treated the same way as the samples. The application volume was 3 liters per square meter in each sample. Water is not included in the dosage in gram per square meter. A total of three samples for each mixture was applied to the soil and the results were averaged.

Before the next wetting event, the system was allowed to harden for 48 h. Subsequently, the samples were watered every two to three days and the experiment was kept running over at least two months. The samples were exposed to exterior light and in addition to artificial growth light with a 12 h rhythm between day and night cycles. During this period, the minimum temperature was 14.5° C. and the maximum temperature was 28.8° C.

The same nomenclature for the alkali silicates as described in example 1 is used. In addition to the abbreviation for the alkali silicates as described above, the application rate is added to the end of the abbreviation by using “—application rate in grams per square meter”, if applicable. Meaning, for example, that a sodium silicate of modulus 4.0 using 100 g/m² application rate was abbreviated by “[Na-M-4.0]−100”.

Weed growth was documented on a regular basis. The coverage rate was determined by manual visual assessment of the plant pots at the specified times, as described in example 1. The coverage rate describes in percent the area covered by weeds. From this in turn the degree of efficiency according to Abbott was calculated as follows:

Degree of efficiency=[coverage rate control(day x)−coverage rate product(day x)]/coverage rate control(day x)*100

Furthermore, the quality of the formed layer was observed regularly with respect to crack formation. The crack appearance was also described as a coverage rate, the percentage corresponding to the total area occupied by cracks. The degree of efficiency is equal to the weed penetration resistance.

Results:

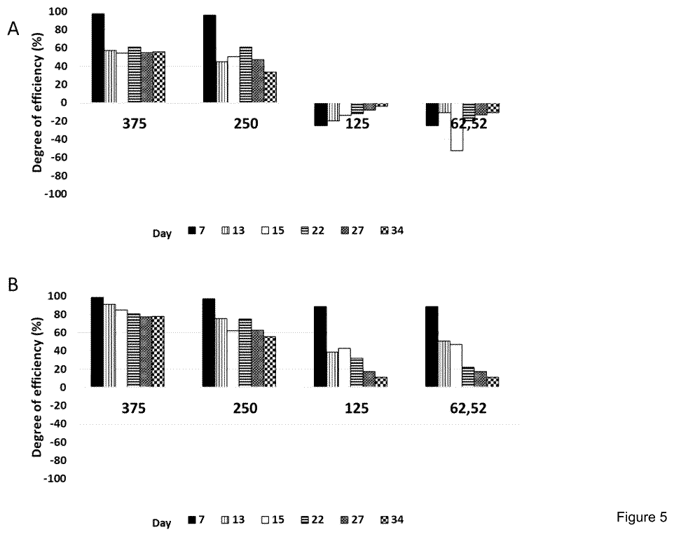

It was surprisingly found that the relationship of the weed control efficiency and the modulus changed, when powdered alkali silicates were used. In contrast to example 1, where liquid alkali silicate of higher modulus did not show effective weed control, in powdered form alkali silicates of higher modulus reduced weed growth more effectively. This is shown in FIG. 5: A lower modululus alkali silicate [Na-M-2.5] (top) does not show effective weed penetration resistance at application rates of 125 g/m², whereas the higher modulus alkali silicate [Na-M-3.3] (bottom) shows weed penetration resistance even at dosages of 62.52 g/m² (e.g. 22% weed penetration resistance after three weeks of experiment).

This effect is especially surprising taking literature on geopolymer systems into account, where lower modulus alkali silicates are necessary for increased reactivity and high quality materials (e.g. Aupoil et al., Interplay between silicate and hydroxide ions during geopolymerization, Cement and Concrete Research, Volume 115, January 2019, Pages 426-432 and references therein). This indicates that in the present case no geopolymerization takes place, which essentially needs high pH-values to polymerise.

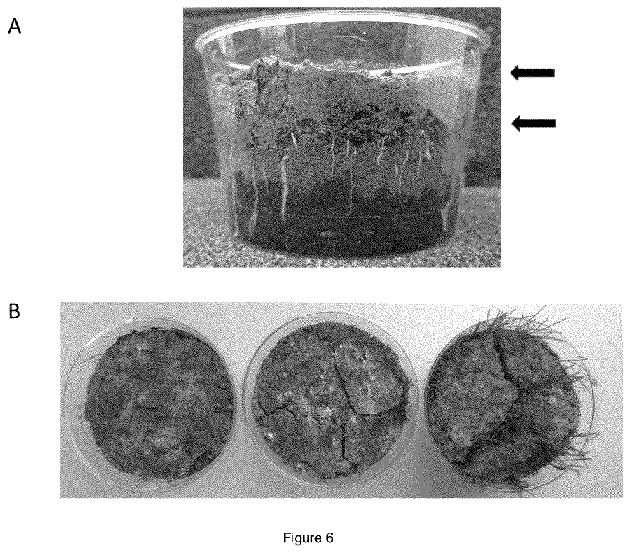

It was observed that the potential to reduce weed growth towards the surface is closely connected to the mechanical properties of the formed soil layer: The effect that weeds are able to germinate and the seedling is not able to penetrate through the formed layer is illustrated in FIG. 6A. This figure indicates a typical sample with effective weed penetration resistance, 7 days after application of a mixture (as defined herein). The weed penetration resistance is 100% in this example. The effect that the powdered, higher modulus sodium silicate [Na-M-3.3] hindered weed growth more efficiently than the lower modulus (=higher alkaline) powdered sodium silicate [Na-M-2.5] can also be explained with the quality of the formed layer: The crust formed with [Na-M-2.5] is more brittle and less resistant to the pressure of the germinating seeds.

Usually the weed penetration resistance efficiency dropped with experiment time (cf. FIG. 5 B), when solid alkali silicates were used alone. This is due to the fact that the formed layer was brittle and that the pressure of the subsequently germinating weeds destroys the formed layer with time. Indeed, parts of the initial layer could be identified as fragments after the experiment. The fragmentation indicated that the binding capacity was durable, but layer quality (e.g. cohesion) was not sufficient.

To increase the quality (e.g. the cohesion) of the formed layer, hardener and/or performance modifiers were added to the solid formulations. This resulted in significantly increased layer quality as shown in FIG. 6 B. On the right-hand side, a sample with pure alkali silicate [Na-M-3.3] using 150 g/m² is shown after 14 days of reaction. Weed penetration resistance was effective, but only where no cracks formed. In the middle of FIG. 6 B, the effect of the hardener calcium chloride is shown: The alkali silicate [Na-M-3.3] was used with 135 g/m² and 15 g/m² calcium chloride was added. By adding the hardener calcium chloride and keeping the dosage rate constant, a better layer with fewer cracks was formed, which resulted in significantly reduced weed penetration through the layer. The cracks in this example just formed on the surface and in the layer beneath these cracks the soil was hardened, elastic and did not allow weeds to penetrate through the layer.

The quality of the formed layer can be further increased when a performance modifier in replacement of the inorganic hardener is added to the mixture. In the present example, 15 g/m² of the performance modifier nanoparticle seeding material (nanosized silica) was used, in replacement for 15 g/m² of the hardener calcium chloride (cf. left-hand side of FIG. 6 B). This modification resulted in an even more cohesive layer and, thus, in higher weed penetration resistance. No weeds grew though the hardened surface, some weeds penetrated in the free space between soil and plastic pot being a clear indication that weed control was mechanical rather than being of a chemical nature. Furthermore, a mixture of the hardener calcium chloride (7.5 g/m²) and the nanoparticle seeding material (7.5 g/m²) was used in replacement for the 15 g/m² of the hardener calcium chloride, maintaining the weed penetration resistance (data not shown).

It was observed that flexible layers, which do not crack upon the pressure of the germinating sprouts result in the most efficient weed control. It was also observed that non-cracking layers were preferably formed when performance modifiers rather than hardeners were used in combination with the alkali silicates. A combination of performance modifiers and hardeners also usually resulted in crack-freeness of the formed layers.

Notably, it was not possible to achieve weed penetration resistance with such low application amounts as described in this present example when liquid alkali silicates were used (cf. example 1). This is due to the fact that dissolution and application to the surface causes a distribution of the alkali silicate species in a bigger soil volume, which results in less efficient hardening. When applied as a powder, the reactive species are positioned on the soil surface, the most effective place to harden soil substrates, if weed control is desired.

The use according to the invention allows easy application of the mixture and efficient weed control: For example, no pre-mixing of the mixture (as defined herein) with the soil substrate was necessary, reducing the work effort and allowing higher productivity, which is a prerequisite for large scale application. Advantageously, the present invention allows weed control with low application rates, necessary for hardening of large area applications, which would not be possible if high application amounts and/or mortar-like substances were used.

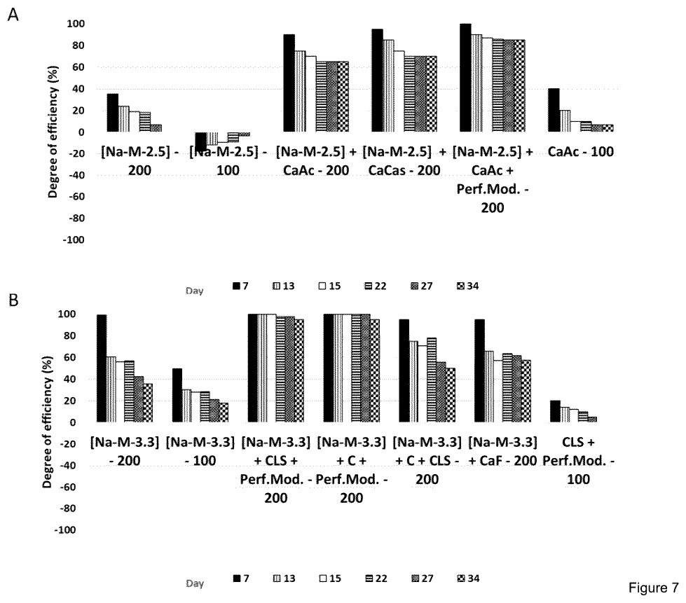

The positive effect of hardeners and/or performance modifiers on weed penetration resistance, and thus the beneficial effect on layer formation, can be seen in FIG. 7. In dosages of 200 g/m² [Na-M-2.5] applied in powdered, solid form is less effective in prevention of weed growth, if compared to [Na-M-3.3] of the same dosage and application form. However, if combined with a performance modifier (Calcium acetate (CaAc) or calcium caseinate (CaCas)) or with a combination of the performance modifiers (CaAc) and nanoparticle seeding material, the weed prevention efficiency increased significantly due to a higher mechanical strength and elasticity of the formed top-layer: When using 200 g/m² [Na-M-2.5] the weed prevention efficiency was 19% after 15 days (FIG. 7A, left graph, non-filled bar). The efficiency using the same application rate was increased to 70% (calcium acetate), 75% (calcium caseinate) and 87% (calcium acetate and nanoparticle seeding material) by the addition of one or more performance modifier(s). The performance modifiers did not result in efficient weed penetration resistance in the used dosage alone, which is exemplified in FIG. 7A on the right-hand side: The weed penetration resistance efficiency of calcium acetate in the dosage being relevant for modifying the hardening of alkali silicates is shown. An effect is observed only at the beginning of the experiment, indicating that the used amount only partially reduces weed growth at the beginning of the experiment and is likely washed away afterwards (due to the watering of the weeds). Here, no hardening reaction takes place, which changes the solubility of the calcium acetate. The effect of initial hardening is not surprising as any soluble material applied to the surface will dissolve upon water addition and reprecipitate in the layer upon initial drying. Notably, the same total application amounts (sum of all applied solids towards the surface in g/m²) were used. Thus, the results in FIG. 7A indicate that a synergistic effect exists between the alkali silicate and the performance modifier(s). The sample [Na-M-2.5]+CaAc is a combination of [Na-M-2.5]−100 and CaAc−100, indicating a synergistic effect on weed penetration resistance increase upon the mixture of alkali silicate and performance modifiers. The use of another performance modifier (nanoparticle seeding material), replacing parts of the calcium acetate in the before mentioned formulation (10 wt.-% of the combined performance modifiers, resulting in 10 g/m² nanoparticle seeding material and 90 g/m² calcium acetate, thus keeping the total application amount constant), even more increases the weed penetration resistance due to more efficient hardening of the formed layer (cf. FIG. 7A). The performance modifier nanoparticle seeding material alone did not show any effect on weed penetration resistance in the applied amount (data not shown).

The weed penetration resistance analysis when higher modulus (i.e. less alkaline) solid sodium silicate [Na-M.3.3] was used in powdered form is shown in FIG. 7 B. The pure alkali silicate in dosages of 200 g/m² and 100 g/m² did not form layers, which were able to completely hinder the weed growth. To further increase weed control, the sodium silicate was mixed with a combination of the hardener calcium chloride (C) and the performance modifier calcium lignin sulfonate (CLS) (2 parts alkali silicate [Na-M-3.3], 1 part calcium chloride, and 1 part calcium lignin sulfonate by weight) or with the performance modifier calcium formate (CaF) (1 part alkali silicate [Na-M-3.3] and 1 part calcium formate by weight). In these mixtures, the formulations formed, upon contact with water, layers, which hindered the penetration of the germinated weeds towards the soil surface. The efficiency of weed penetration resistance after 15 days was increased from 55% (pure [Na-M-3.3]) to 75% (addition of calcium chloride and calcium lignin sulfonate) or 65% (calcium formate) when a hardener and/or performance modifier were used. Notably, the identical total application amounts (sum of all applied solids to the surface in g/m²) were used. Thus, a synergistic effect exists between the performance modifier (and hardener) and the alkali silicate. Replacing the hardener calcium chloride by performance modifier cellulose ester, keeping the total application amount constant, results in even more efficient weed penetration resistance, e.g. reaching up to 100% after 15 days ([Na-M-3.3]+CLS+Perf.Mod.−200, Perf.Mod.=cellulose ester) (cf. FIG. 7 B). A list of further tested performance modifiers is provided below. Exchange of the performance modifier calcium lignin sulfonate with the performance modifier saccharose (from [Na-M-3.3]+C+CLS−200 to [Na-M-3.3]+C+Perf.Mod.−200, Perf.Mod.=saccharose) resulted in very efficient weed control, indicating that the performance modifiers have a significant influence on performance of the formed layer. Indeed, the influence of the performance modifiers was bigger than that of the hardeners when present in alkali silicate formulations, comparing similar application rates.

In a series of experiments, a variety of performance modifiers were tested in the above mentioned mixture ([Na-M-3.3]+CLS+Perf.Mod., 200 g/m²), Perf.Mod. being non-proteinogenic amino acid N-(1-carboxyethyl)-iminodiacetic acid, L-alanin, poly glutamic acid, kraft lignin, styrene acrylate, cellulose esters, glucose, microsilica, calcium propionate), all showing similar performance of the formed layer and increased weed penetration resistance compared to the respective control (data not shown).

Also, these performance modifiers were used in an alkali silicate formulation with [K-M-3.3] using 200 g/m² (1 part per weight [K-M-3.3] and 1 part per weight performance modifier) showing synergistic effects on weed penetration resistance. This indicates that the performance modifiers non-proteinogenic amino acid N-(1-carboxyethyl)-iminodiacetic acid, L-alanin, poly glutamic acid, kraft lignin, styrene acrylate, cellulose esters, glucose, microsilica, calcium propionate, metakaolin change reactivity of the alkali silicate resulting in higher weed control (data not shown).

Changing the relative proportions in an alkali silicate formulation of the performance modifier (calcium lignin sulfonate or calcium formate) from 9 parts per weight performance modifier and 1 part per weight alkali silicate [Na-M-3.3] to 1 part per weight performance modifier and 9 parts per weight alkali silicate, keeping the application rate constant, showed higher weed control than the single components indicating synergistic effects between alkali silicates and performance modifiers (data not shown).

The experiments were kept running over the time reported in the figures. Generally, after 34 days, the performance did not change significantly (change observed was plus/minus 10%, thus not relevant in the accuracy of the proposed setup), indicating a durable weed prevention effect, when a weed preventing layer is formed.

In a further experiment, the previously used alkali silicate [Na-M-3.3] having a maximum of the particle size (diameter) distribution at 125 μm (less than 5% of particles being bigger than 250 μm and less than 15% of particles being smaller than 63 μm) was replaced with a [Na-M-3.3] having a maximum of the particle size distribution at 80 μm (less than 2% of particles being bigger than 250 μm and less than 40% of particles being below 63 μm).

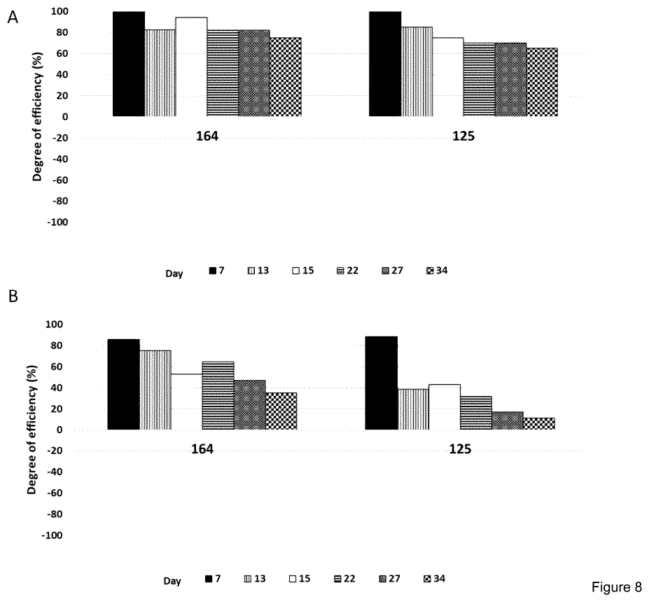

Doing so, the weed penetration efficiency after 15 d was increased from 53% to 94% using the pure alkali silicate (cf. FIG. 8). Alkali silicates with even bigger size were tested showing further reduced weed penetration resistance. Smaller particles dissolve better and, thus, form a higher quality weed penetration resistant layer. This was also found in a joint sand formulation, where solid alkali silicates of a diameter below 125 μm were mixed with sand and applied to a soil substrate. The weed penetration resistance of the formed layer was better compared to a joint sand with bigger sized alkali silicate.

### Example 3: Field Application Tests

Material and Methods:

The experiment was carried out in three different outdoor locations: a vineyard and two different agricultural soils. The agricultural soils differed by location, weed growth pressure and composition: a loamy land soil and a sandy land soil.

Accordingly, the soil substrate was as found in natural form at the location of the experiment. In all cases, the soil substrates exhibited humic content.

Different mixtures were used in this experiment, which are described in detail below and follow the nomenclature of the examples above.

The application rate per square meter was 3 liters per square meter. The alkali silicate and/or mixture dosages per square meter were obtained by diluting the highly concentrated alkali silicate stock solutions to the applicable concentration using tap water. Each dosage in grams per square meter mentioned below refers to the alkali silicate and/or hardener and/or performance modifier dosage per square meter. Water is not included in the mass in gram per square meter. Liquid and solid alkali silicates or mixtures were used as detailed below. As a control (untreated control), water 3 l/m² was applied purely to a separate plot. As a chemical herbicide control, Roundup (glyphosate based herbicide) was used as described by the manufacturer.

The mixtures were applied to the soil surface and left to exterior conditions for three months. No rain occurred for at least 48 hours after application. For each mixture, 30 meters (45 m²) of lower floor area (vineyard) or 5 m² (agricultural soils, respectively) were treated. Occurrence of rain in the vineyard was 120 liters per square meter, on the loamy land 400 liters per square meter, and on the sandy land 200 liters per square meter in the three months of the experiment. The wine yield was determined by weighing the wine grapes after harvest.

The documentation of the weed growth was done by two experienced raters, the first rater having more than 20 years of experience in weed control and the second rater having 5 years of experience in weed control. A rating scale from 1 (no weed occurrence on the soil surface) to 9 (weeds on any visible spot, corresponding to 100% coverage rate) was used, as known to people skilled in the art. The mentioned ratings are average values of the two raters.

Calcium hydroxide (Ca(OH)₂) is the hardener in these formulations, nanoparticle seeding material (nanosized silica) and/or calcium lignin sulfonate (CLS) and/or calcium acetate were used as performance modifiers.

Results:

Mechanical weed control was observed in all outdoor experiments.

Vineyard:

The higher penetration resistance with the pre-application of a performance modifier to the soil was demonstrated in outdoor application: Approximately 33% less weed growth was observed when the performance modifier was used with respect to the control without performance modifier. In general, no negative influence of alkali silicate or mixture application on plant viability of the existing plants was observed. A higher yield (15% higher weight of the grapes from the plot of [Na-M-2.5]+CLS with respect to the water control) of the wine was observed with respect to untreated control, likely due to evaporation control.

TABLE 1
Rating of weed growth two months after application using different
liquid alkali silicates and mixtures in a vineyard

| Mixture | Rating Weed Growth (1-9) |
|---|---|
| Untreated control (UTC) | 6 |
| Chemical Control − (Roundup − | 3 |
| Glyphosate)* | |
| [Na-M-2.5] − 450 | 3 |
| [Na-M-2.5] − 425 + CLS − 25 | 2 |

*used as described in the manual from the manufacturer by a person skilled in the art

Agricultural Soils:

By application to the two different agricultural soils, the alkali silicate and mixtures showed mechanical weed control: Most strikingly, the application of powdered alkali silicates resulted in efficient layer formation and high weed control, even on a soil with high weed pressure (cf. Table 3). By using one or more performance modifier(s), the performance of the weed penetration resistant layer was significantly improved when compared to pure alkali silicates.

Mechanical weed control was confirmed by opening the formed layer with a spade. Observing the formed layer from the side showed a comparable picture than shown in FIG. 6: The seedlings showed viability but no growth towards the soil surface.

TABLE 2
Rating of weed growth two months after application using different
liquid alkali silicates and mixtures on a loamy agricultural soil

| Mixture | Rating Weed Growth (1-9) |
|---|---|
| Untreated control (UTC) | 4 |
| Chemical Control − (Roundup − | 2 |
| Glyphosate)* | |
| [Na-M-1.7] − 350 | 3 |
| [Na-M-1.7] − 325 + Ca(OH)₂ − 25 | 2 |

*used as described in the manual from the manufacturer by a person skilled in the art

TABLE 3
Rating of weed growth two months after application using
different powdered alkali silicates and mixtures on the
sandy agricultural soil with higher weed growth pressure

| Mixture | Rating Weed Growth (1-9) |
|---|---|
| Untreated control (UTC) | 7 |
| Chemical Control − (Roundup − | 2 |
| Glyphosate)* | |
| [Na-M-2.5] − 200 | 5 |
| [Na-M-2.5] − 150 + CaAc − 50 | 3 |
| [Na-M-2.5] − 125 + CaAc − 50 + | 1 |
| Nanoparticle Seeding Material − 25 | |

*used as described in the manual from the manufacturer by a person skilled in the art

In all experiments, the use of mixtures (as defined above) resulted in layer formation, which hinders weed growth with a comparable, in some cases even a higher, efficiency than the chemical control acting with a different mode of action (cf. Tables 1 and 2). Table 3 shows that the alkali silicate formulation comprising [Na-M-2.5] and the performance modifiers calcium acetate and nanoparticle seeding material showed better performance than the chemical control.

### Example 4: Mechanical Weed Control and Influence of Alkali Silicates and Mixtures on Seed Germination Rate

Material and Methods:

Layer-Effect Experiment

Humic soil (200 g) was placed in a plastic pot. On top of the humic soil, 50 g of sifted land soil was placed. Both soil substrates were free of weed growth prior to treatment. Into the 50 g of sifted land soil plant seeds (0.2 g Plantago lanceolate seed (ribwort plantain) and 0.1 g Poa annua seeds (annual meadow grass) [Seed Set 4.1] or 0.1 g Phazelia (Phacelia tanacetifolia) seeds [Seed Set 4.2] or 0.1 g Chinese cabbage seeds [Seed Set 4.3]) were placed (a separate beaker was prepared for each seed set). Onto this soil layer, a layer of gravel (approx. 50 g, one separating monolayer) was placed. Onto the gravel layer, 250 g of sifted land soil was placed. Onto the top layer, alkali silicates or mixtures (cf. details below) were applied and watered using 3 l/m² of water. The setup was designed in a way that this initially applied water volume was only sufficient to penetrate half of the soil volume. Thus, a direct physical contact between the alkali silicates or mixtures and the seeds was prevented. Both soils contained minimal residues of endemic weed seeds or inflowing seeds. These present seeds were not sufficient for efficient weed growth. As a control, no alkali silicate or mixture was placed on the top layer of the soil and treated in accordance with the treated samples.

The pots were placed on a tablet to allow watering from the bottom. After the initial application of the water, which resulted in reaction of the alkali silicate or mixture, respectively, the pots were watered every two to three days from the bottom and the experiment was kept running over at least two months. This setup allowed the absence of physical contact between the alkali silicates or mixtures and the seeds. The samples were exposed to exterior light and in addition to artificial growth light with a 12 h rhythm between day and night cycles. During this period, the minimum temperature was 14.5° C. and the maximum temperature was 28.8° C.

Alkali silicates [Na-M-2.5], [K-M-3.3], [Na-M-3.3] (cf. definitions in example 1) were used in application rates of 150 g/m² in solid and in liquid form. Furthermore, any combination of the alkali silicate [Na-M-3.3] with any hardeners and/or performance modifiers from the list below was applied to the surface:

Used hardeners in this experiment: Calcium chloride, magnesium chloride, iron chloride, calcium carbonate.

Used performance modifiers in this experiment: Potassium humate, glucose, lactic acid, calcium lactate, D/L-alanin, trisodium dicarboxymethyl alaninate (trilon M), albumin, sodium lignin sulfonate, magnesium lignin sulfonate, potassium lignin sulfonate, calcium caseinate, calcium acetate, calcium lignin sulfonate, kraft-lignin.

The nomenclature as described in the previous examples was used to report the alkali silicate and the application rate of the hardeners and/or performance modifiers. The alkali silicate formulation of 50 wt.-% [Na-M-3.3] and 50 wt.-% CLS in the application rate of 150 g/m², for example, was abbreviated by [Na-M-3.3]−75+CLS−75, corresponding to 75 g/m² of the alkali silicate [Na-M-3.3] and the hardener calcium lignin sulfonate, respectively. The degree of efficiency was determined as described in the examples 1 and 2.

Germination Rate

100 seeds of Plantago lanceolate seed (ribwort plantain) [Seed Set 4.4], 100 seeds of Poa annua seeds (annual meadow grass) [Seed Set 4.5], 100 seeds of Phazelia tanacetifolia (Phacelia) [Seed Set 4.6] and 50 seeds of Brassica rapa pekinensis (Chinese cabbage) [Seed Set 4.7] were separately placed in different pots for exposure to the alkali silicates. Subsequently, each set of seeds (Seed Set 4.4 to 4.7) was exposed to 20 wt.-% alkali silicate solutions [Na-M-2.5], [Na-M-3.3] as well as deionized water (control sample) and left to incubate for 24 h. After the exposure, the seeds were washed with deionized water (three times with 40 mL) and placed on a paper towel, wetted with deionized water, covered with a plastic foil and exposed to day light for 7 days. During this period, the minimum temperature was 14.5° C. and the maximum temperature was 25.8° C.

After one, two, three and seven days, the amount of germinated seeds was determined by counting. The germination rate in percent was determined by dividing the number of germinated seeds by the total number of seeds multiplied by 100.

Results:

Layer-Effect Experiment

The physical contact between the alkali silicates or mixtures and the seeds was excluded by the experimental setup. Application of alkali silicate or mixture resulted in the formation of a layer which reduced weed growth. If weeds occurred on the surface, they grew through cracks within the layer. Especially in the presence of performance modifiers, a hard and flexible layer was formed without the occurrence of cracks. Thus, in this case the weed penetration resistance resulted in more efficient weed control. This is illustrated in FIG. A where the experiment using mixture [K-M-3.3]−75+CLS−50+CaCl₂)−20+nanoparticle seeding material−5 is shown 14 days after application. The degree of efficiency is 100% as no weed penetrated to the surface. Due to the high seed amount, this test can again be rated as a stress test.

All above mentioned mixtures showed layer formation and positive weed penetration efficiency. A selection of the results is summarized in table 4.

TABLE 4
Weed control efficiency of alkali silicate [Na-M-3.3] and mixtures in the
layer experiment using phazelia seeds. In this experiment, the physical contact
between alkali silicate or mixture and the seeds was prevented, respectively.

| | Degree of | Degree of | Degree of | Degree of |
|---|---|---|---|---|
| | efficiency | efficiency | efficiency | efficiency |
| Alkali silicate or | after 3 | after 7 | after 14 | after 21 |
| mixture | days in % | days in % | days in % | days in % |
| [K-M-3.3] − 150 | 85 | 75 | 70 | 65 |
| [K-M-3.3] − 75 + CLS − 75 | 100 | 90 | 90 | 85 |
| [K-M-3.3] − 75 + CLS − 50 + | 100 | 100 | 100 | 95 |
| CaCl₂ − 20 + | | | | |
| nanoparticle seeding | | | | |
| material − 5 | | | | |
| [K-M-3.3] − 75 + | 100 | 90 | 90 | 90 |
| magnesium lignin | | | | |
| sulfonate − 75 | | | | |
| [K-M-3.3] − 75 + CLS − 40 + | 100 | 90 | 90 | 90 |
| CaAc − 35 | | | | |
| [Na-M-3.3] − 75 + | 100 | 90 | 90 | 90 |
| CaAc − 45 + CaCl₂ − | | | | |
| 20 + calcium lactate − 10 | | | | |
| [K-M-3.3] − 75 + | 100 | 95 | 95 | 95 |
| CaAc − 65 + | | | | |
| polyvinyl alcohol − 10 | | | | |
| [K-M-3.3] − 75 + | 100 | 95 | 90 | 90 |
| calcium caseinate − | | | | |
| 25 + CaAc − 50 | | | | |

Due to the absence of physical contact between weed seeds and the alkali silicate or mixture, a chemical mode of action can be excluded. It can be again concluded that the weed growth prevention of the hardened layer is due to mechanical barrier formation and the prevention of weed penetration to the surface.

Germination Rate

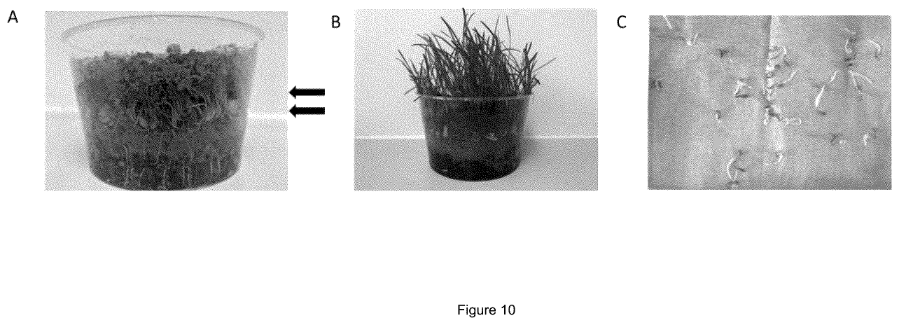

Exposure of the seeds to the alkali silicates [K-M-3.3] and [K-M-2.5] for 24 hours did not influence the germination rate of any of the seeds. After three days of wet incubation, 98% of the seeds germinated after the exposure to the alkali silicate solutions and deionized water (control). A photograph of the germinated ribwort plantain after two days is shown in FIG. 10 C. The germination rate after three days was 98%, whereas the germination rate of the seeds exposed to water (control) for the same time was 98%. This indicates that the alkali silicates did not change the germination rate by chemical means.

The same results were obtained with the other plant seeds. Also, longer incubation times (2, 3 and 7 days) of alkali silicate or mixtures were tested and did not influence the germination rate of the seeds (data not shown).

### Example 5: Successive Application of Liquid Performance Modifier (and Hardener) and Alkali Silicate Solutions and Premixing of the Components

Material and Methods:

Layer-Effect Experiment

Humic soil (200 g) was placed in a plastic pot. On top of the humic soil, 50 g of sifted land soil was placed. Both soil substrates were free of weed growth prior to treatment. Into this 50 g of sifted land soil plant seeds (0.2 g Plantago lanceolate seed (ribwort plantain) and 0.1 g Poa annua seeds (annual meadow grass) [Seed Set 5.1] or 0.1 g Phazelia (Phacelia tanacetifolia) seeds [Seed Set 5.2] or 0.1 g Chinese cabbage seeds [Seed-Set 5.3]) were placed (a separate beaker was prepared for each seed set). Onto this soil layer, a layer of gravel (approx. 50 g, one separating monolayer) was placed. Onto the gravel layer, 250 g of sifted land soil was placed. Onto the top layer, alkali silicate or mixture were applied in liquid form using in total 3 l/m². The setup was designed in a way that this initially applied water volume (contained in the alkali silicate or mixture solution) was only sufficient to penetrate half of the soil volume. Thus, a direct physical contact between the solutions and the seeds was prevented. Both soils contained minimal residues of endemic weed seeds or inflowing seeds. These present seeds were not sufficient for efficient weed growth. As a control, no alkali silicate or mixture was placed on the top layer of the soil and treated in accordance with the treated samples.

In this experiment, three different orders of application were tested:
a) First the performance modifier(s) (and hardener) using 1.5 l/m² application volume were applied, followed by the application of the liquid alkali silicate
b) First the alkali silicate using 1.51/m² application volume were applied, followed by the application of the liquid performance modifier(s) (and hardener)
c) Premixing of the alkali silicate and the performance modifier(s) (and hardener) The same nomenclature as in the previous examples was used. Non-viable bacterial mass was obtained using E. coli W3110. The cells were cultivated in LB media under standard conditions (cf. Behr et al. 2014, Identification of a novel nutrient-sensing histidine kinase/response regulator network in Escherichia coli, Journal of bacteriology, 196(11), 2023-2029). After reaching the end of the stationary phase, cultivation was terminated and the liquid cell broth autoclaved. The resulting residues were dried.

Results:

The application order significantly influences the outcome of the mechanical layer formation, as indicated in table 5. That the order of addition determines the outcome of an experiment is a typical characteristic of a construction system, demonstrating that the use of alkali silicates in combination with performance modifiers results in mechanical weed control, rather than chemical interaction. If the interaction would have been driven by chemical means, the performance of the experiments a), b) and c) would have been expected to be more similar than shown in table 5.

TABLE 5
Weed control efficiency of mixtures based on the alkali silicates
[Na-M-3.3], [K-M-3.3] and [Na-M-2.5] in the
layer experiment using phazelia seeds with different order of
addition of the alkali silicate and the hardener and/or performance
modifier. In this experiment, the physical contact between alkali
silicate or mixture and the seeds was prevented, respectively.

| | Degree of | Degree of | Degree of |
|---|---|---|---|
| | efficiency | efficiency | efficiency |
| | after 14 | after 14 | after 14 |
| | days in % | days in % | days in % |
| Alkali silicate or | Order of addition | | |
| mixture | a | b | c |
| [K-M-3.3] − 100 + | 85 | 55 | 65 |
| magnesium lignin | | | |
| sulfonate − 50 + | | | |
| calcium acetate − 50 | | | |
| [K-M-3.3] − 100 + CLS − 50 + | 70 | 50 | 55 |
| CaCl₂ − 50 | | | |
| [Na-M-3.3] − 100 + | 75 | 45 | 55 |
| calcium propionate − 50 + | | | |
| albumin − 50 | | | |
| [Na-M-2.5] − 100 + | 85 | 50 | 80 |
| calcium lignin sulfonate − 100 | | | |
| [Na-M-2.5] − 100 + L- | 90 | 50 | 90 |
| alanin − 50 + albumin − | | | |
| 50 | | | |
| [K-M-3.3] − 50 + | 90 | 60 | 90 |
| magnesium lignin | | | |
| sulfonate − 50 + sodium | | | |
| alginate − 5 + calcium | | | |
| chloride − 45 | | | |
| [K-M-3.3] − 50 + | 90 | 70 | 90 |
| magnesium lignin | | | |
| sulfonate − 50 + sodium | | | |
| alginate − 5 + | | | |
| potassium humate − 5 + | | | |
| calcium chloride − 40 | | | |
| [K-M-3.3] − 50 + | 90 | 75 | 90 |
| magnesium lignin | | | |
| sulfonate − 40 + poly | | | |
| aspartic acid − 5 + | | | |
| acetic acid − 5 + | | | |
| calcium chloride − 40 | | | |
| [K-M-3.3] − 50 + | 90 | 80 | 90 |
| magnesium lignin | | | |
| sulfonate − 40 + corn | | | |
| gluten meal − 30 + | | | |
| calcium chloride − 25 | | | |
| [K-M-3.3] − 50 + | 90 | 85 | 90 |
| magnesium lignin | | | |
| sulfonate − 40 + corn | | | |
| gluten meal − 30 + | | | |
| silicate cement − 20 | | | |
| [K-M-3.3] − 25 + (exo) | 90 | 90 | 90 |
| polysaccharide − 50 + | | | |
| non-viable bacterial | | | |
| mass − 30 + iron | | | |
| sulfate − 25 | | | |
| [K-M-3.3] − 25 + natural | 90 | 90 | 90 |
| latex − 45 + non- | | | |
| preoteinogenic amino | | | |
| acid trisodium α-DL- | | | |
| alanine diacetate − 35 + | | | |
| calcium sulfate − 25 | | | |
| [K-M-3.3] − 70 + | 80 | 80 | 90 |
| calcium lignin sulfonate − | | | |
| 25 + magnesium | | | |
| lignin sulfonate − 25 + | | | |
| [K-M-3.3] − 70 + | 90 | 80 | 80 |
| calcium caseinate 15 + | | | |
| magnesium lignin | | | |
| sulfonate − 25 + | | | |
| saccharose − 15 | | | |

1-15. (canceled)

16. A method for reducing or preventing plant growth on/from a substrate, the method comprising:
(A) applying a mixture free from silicate cement and aluminate cement onto/into the substrate, the mixture comprising:
(a) one or more alkali silicates selected from lithium silicate, sodium silicate, potassium silicate, rubidium silicate, caesium silicate, or mixtures thereof;
(b) one or more performance modifiers selected from:
(i) (bio)polymers, wherein the one or more (bio)polymers are selected from:
cellulose, starch, lignin, lignin sulfonates, kraft-lignins and lignin carboxylates, pectins, and guarethers;
algin, cylcodextrins, and dextrins;
natural glues, hydrogel builders, plant lime, and latex;
proteins and peptides comprising one or more amino acids selected from alanine, glycine, lysine, asparagine, glutamine, glutamate, and non-proteinogenic amino acids;
corn steep liquor, lactose mother liquor, protein lysates and molasses, vegetable meals, fruit meals, and protein wastes;
starch ethers, starch esters, starch carboxylates, cellulose esters, cellulose ethers, cellulose carboxylates, yeasts, and extracts thereof;
liquid or dried polymer dispersions or polymers comprising organic acids, salts thereof, cyanates, ethers, oxides, sulfates, nitriles, aldehydes, ketones, alcohols, thiols, siloxanes, phosphates, and phosponates;
(ii) (poly)saccharides and extracellular substances selected from (poly)saccharides comprising lactose, glucose, fructose, saccharose, and/or galactose, and microbial exopolysaccharides;
(iii) organic acids and carboxylates and esters thereof; and
(iv) amino acids and derivatives thereof;
(c) one or more hardeners selected from:
(v) inorganic salts selected from alkali salts, earth alkali salts, metal salts, and transition metal salts; and
(vi) inorganic binders selected calcium sulfate, calcium oxide, and phosphate binders; and
(B) reacting the mixture with the substrate to form a hardened substrate layer that resists plant growth;
wherein the amount of the mixture applied onto/into the substrate per application is less than 300 g/m².

17. The method of claim 16, wherein the one or more hardeners are selected from calcium carbonate, calcium hydrogen carbonate, calcium chloride, calcium hydroxide, calcium sulfate, magnesium carbonate, magnesium hydrogen carbonate, magnesium chloride, magnesium sulfate, aluminum sulfate, iron chloride, iron sulfate, and phosphates thereof.

18. The method of claim 16, wherein the substrate comprises one or more materials selected from soil, humus, crushed stone, gravel, clay, silt, sawdust, paper, cardboard, chipboard, softwood, limestone, and coal.

19. The method of claim 16, wherein the substrate is an area of land selected from a garden area, area of arable land, an orchard, a vineyard area, a tree nursery area, a park area, part of a developed land or urban area, an unpaved road, a footpath, a railway line, an industrially used area, and an area between and before said areas of land.

20. The method of claim 16, wherein the mixture applied onto/into the substrate is a liquid form, a gel, a paste, a powder, granulates or aggregates, or intermediate forms thereof.

21. The method of claim 16, wherein the one or more alkali silicates of (a) include potassium silicate.

22. The method of claim 16, wherein the amount of mixture applied onto/into the substrate is less than 200 g/m², per application.

23. The method of claim 16, wherein lateral dimensions of the substrate are greater than 0.5 cm.

24. The method of claim 16, further comprising:
(C) promoting growth of wanted plants by erosion control, water evaporation control, and/or the supply of nutrients.

25. A method for preventing or reducing plant growth on/in a substrate, the method comprising:
(A) identifying a substrate to be treated on/in which plant growth is to be prevented or reduced;
(B) providing a mixture comprising:
(a) one or more alkali silicates selected from lithium silicate, sodium silicate, potassium silicate, rubidium silicate, caesium silicate, or mixtures thereof;
(b) one or more performance modifiers selected from:
(i) (bio)polymers, wherein the one or more (bio)polymers are selected from:
cellulose, starch, lignin, lignin sulfonates, kraft-lignins and lignin carboxylates, pectins, and guarethers;
algin, cylcodextrins, and dextrins;
natural glues, hydrogel builders, plant lime, and latex;
proteins and peptides comprising one or more amino acids selected from alanine, glycine, lysine, asparagine, glutamine, glutamate, and non-proteinogenic amino acids;
corn steep liquor, lactose mother liquor, protein lysates and molasses, vegetable meals, fruit meals, and protein wastes;
starch ethers, starch esters, starch carboxylates, cellulose esters, cellulose ethers, cellulose carboxylates, yeasts, and extracts thereof;
liquid or dried polymer dispersions or polymers comprising organic acids, salts thereof, cyanates, ethers, oxides, sulfates, nitriles, aldehydes, ketones, alcohols, thiols, siloxanes, phosphates, and phosponates;
(ii) (poly)saccharides and extracellular substances selected from (poly)saccharides comprising lactose, glucose, fructose, saccharose, and/or galactose, and microbial exopolysaccharides;
(iii) organic acids and carboxylates and esters thereof;
(iv) amino acids and derivatives thereof;
(c) one or more hardeners selected from:
(v) inorganic salts selected from alkali salts, earth alkali salts, metal salts, and transition metal salts; and
(vi) inorganic binders selected calcium sulfate, calcium oxide, and phosphate binders; and
(C) applying and/or introducing the mixture onto/into the substrate to be treated, in an amount sufficient to enable hardening of the substrate; and
(D) forming one or more hardened layers or areas on/in the substrate so that plant growth on/in the substrate is prevented or reduced;
wherein the amount of the mixture applied to the substrate per application is less than 300 g/m².

26. The method of claim 25, wherein the one or more hardeners are selected from calcium carbonate, calcium hydrogen carbonate, calcium chloride, calcium hydroxide, calcium sulfate, magnesium carbonate, magnesium hydrogen carbonate, magnesium chloride, magnesium sulfate, aluminum sulfate, iron chloride, iron sulfate, and phosphates thereof.

27. The method of claim 25, wherein the substrate comprises one or more materials selected from soil, humus, crushed stone, gravel, clay, silt, sawdust, paper, cardboard, chipboard, softwood, limestone, and coal.

28. The method of claim 25, wherein the substrate is an area of land selected from a garden area, area of arable land, an orchard, a vineyard area, a tree nursery area, a park area, part of a developed land or urban area, an unpaved road, a footpath, a railway line, an industrially used area, and an area between and before said areas of land.

29. The method of claim 25, wherein the mixture applied onto/into the substrate is a liquid form, a gel, a paste, a powder, granulates or aggregates, or intermediate forms thereof.

30. The method of claim 25, wherein the one or more alkali silicates of (a) includes potassium silicate.

31. The method of claim 25, wherein lateral dimensions of the substrate are greater than 0.5 cm.

32. The method of claim 25, wherein the mixture comprises:
(a) one or more alkali silicates selected from lithium silicate, sodium silicate, potassium silicate, rubidium silicate, caesium silicate and mixtures thereof, wherein the modulus M of the one or more alkali silicates is >1.7;
(b) two or more performance modifiers independently selected from:
(i) (bio)polymers selected from:
cellulose, starch, lignin, lignin sulfonates, kraft-lignins and lignin carboxylates, pectins, and guarethers;
algin, cylcodextrins, and dextrins;
natural glues, hydrogel builders, plant lime, and latex;
proteins and peptides comprising one or more amino acids selected from alanine, glycine, lysine, asparagine, glutamine, glutamate, and non-proteinogenic amino acids;
corn steep liquor, lactose mother liquor, protein lysates and molasses, vegetable meals, fruit meals, and protein wastes;
starch ethers, starch esters, starch carboxylates, cellulose esters, cellulose ethers, cellulose carboxylates, yeasts, and extracts thereof;
liquid or dried polymer dispersions or polymers comprising organic acids, salts thereof, cyanates, ethers, oxides, sulfates, nitriles, aldehydes, ketones, alcohols, thiols, siloxanes, phosphates, and phosponates;
(ii) (poly)saccharides and extracellular substances selected from (poly)saccharides comprising lactose, glucose, fructose, saccharose, and/or galactose, and microbial exopolysaccharides;
(iii) organic acids and carboxylates and esters thereof;
(iv) amino acids and derivatives thereof;
(c) one or more hardeners selected from:
(v) inorganic salts selected from alkali salts, earth alkali salts, metal salts, and transition metal salts; and
(vi) inorganic binders selected calcium sulfate, calcium oxide, and phosphate binders.

33. A mixture for preventing or reducing plant growth comprising:
(a) one or more alkali silicates selected from lithium silicate, sodium silicate, potassium silicate, rubidium silicate, caesium silicate and mixtures thereof, wherein the modulus M of the one or more alkali silicates is >1.7;
(b) two or more performance modifiers independently selected from:
(i) (bio)polymers selected from:
cellulose, starch, lignin, lignin sulfonates, kraft-lignins and lignin carboxylates, pectins, and guarethers;
algin, cylcodextrins, and dextrins;
natural glues, hydrogel builders, plant lime, and latex;
proteins and peptides comprising one or more amino acids selected from alanine, glycine, lysine, asparagine, glutamine, glutamate, and non-proteinogenic amino acids;
corn steep liquor, lactose mother liquor, protein lysates and molasses, vegetable meals, fruit meals, and protein wastes;
starch ethers, starch esters, starch carboxylates, cellulose esters, cellulose ethers, cellulose carboxylates, yeasts, and extracts thereof;
liquid or dried polymer dispersions or polymers comprising organic acids, salts thereof, cyanates, ethers, oxides, sulfates, nitriles, aldehydes, ketones, alcohols, thiols, siloxanes, phosphates, and phosponates;
(ii) (poly)saccharides and extracellular substances selected from (poly)saccharides comprising lactose, glucose, fructose, saccharose, and/or galactose, and microbial exopolysaccharides;
(iii) organic acids and carboxylates and esters thereof;
(iv) amino acids and derivatives thereof;
(c) one or more hardeners selected from:
(v) inorganic salts selected from alkali salts, earth alkali salts, metal salts, and transition metal salts; and
(vi) inorganic binders selected calcium sulfate, calcium oxide, and phosphate binders;
wherein the mixture does not comprise silicate cement and aluminate cement.
